(19) United States
(12) Patent Application Publication
(10) Pub. No.: US 2025/0184031 A1
(43) Pub. Date: Jun. 5, 2025

(54) SYSTEM AND METHOD FOR COUNTERING DISTANCE MANIPULATION ATTACKS

(71) Applicants: DENSO International America, Inc., Southfield, MI (US); DENSO CORPORATION, Kariya-shi (JP)

(72) Inventor: Kyle Golsch, Pontiac, MI (US)

(21) Appl. No.: 18/960,314

(22) Filed: Nov. 26, 2024

Related U.S. Application Data
(60) Provisional application No. 63/604,520, filed on Nov. 30, 2023.

(51) Int. Cl. H04K 3/00; H04W 12/108

(52) U.S. Cl. CPC H04K 3/86; H04W 12/108

(57) ABSTRACT

A system and method provided for detecting or mitigating distance attacks against real-time location systems for determining a position of a remote device relative to an object or device. The system and method may utilize phase coherency in conjunction with a time of arrival estimate as a basis for detecting or mitigating distance attacks.

### FIELD OF INVENTION

The present disclosure relates to a system and method for determining a distance between a remote device and an object, such as a vehicle, and more particularly to countering distance manipulation attacks.

### BACKGROUND

Real-time location or position determinations for objects have become increasingly prevalent across a wide spectrum of applications. Real-time locating systems (RTLS) are used and relied on for tracking objects, such as portable or remote devices, in many realms including, for example, automotive, storage, retail, security access for authentication, and security access for authorization.

In conventional applications that employ time of arrival and time of departure estimations in order to perform Round Trip Time (RTT) radio exchanges in order to perform a Time of Flight (ToF) measurement used to calculate the distance between devices, the receiving device compares the incoming received signal with a reference expected signal in order to estimate the time delay of the incoming signal as well as check for the integrity of the received signal. An attacker who wishes to attack the distance measurement by causing the receiver to estimate an invalid time of arrival may create a signal that will cause a desired timing error and inject it into the victim receiver. The legitimate device that is the source of the legitimate signal is referred to as the victim transmitter. The legitimate device that is a destination is referred to as the victim receiver. There may be many victim receivers in a Time Difference of Arrival (TDOA) application. The attacker is a malicious device or devices that is in between the victim transmitter and victim receiver(s) and has the capability of receiving signals from the victim receiver and transmitting signals into the victim receiver(s).

Conventional systems have been shown to be susceptible to an attack that an attacker may implement to advance a victim receiver's timing estimation such that it is estimated to be earlier than reality in order to make the distance to the victim transmitter appear shorter than reality. This type of attack may be used in applications like secure access or secure payments, where an attacker may make it appear that an end user's device is closer to a location than it actually is. Such conventional attacks may be implemented on frequency shift keying narrowband signals such as the Gaussian Frequency Shift Keying (GFSK) employed by Bluetooth. However, this type of conventional attack may be effective on other types of modulated data as it relies on a family of filters that cause a negative group delay, and such a filter can be found for any signal.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### SUMMARY

In general, one innovative aspect of the subject matter described herein

### BRIEF DESCRIPTION OF THE DRAWINGS

FIG. 1 shows a system in accordance with one embodiment of the present disclosure.

FIG. 2 shows a system in accordance with one embodiment.

FIG. 3 shows a device of the system in one embodiment.

FIG. 4 shows a portion of the device of the system in accordance with one embodiment.

FIG. 5 shows the system in accordance with one embodiment.

FIG. 6 shows the system in accordance with one embodiment.

FIG. 7 shows a device of the system in accordance with one embodiment.

FIG. 8 depicts communications according to one embodiment.

FIG. 9 shows communications according to one embodiment.

FIG. 10 shows phase wrapping for communications according to one embodiment.

FIG. 11 shows reference symbols according to one embodiment.

FIG. 12 shows a reference signal phase according to one embodiment.

FIG. 13 depicts a reference signal frequency according to one embodiment.

FIG. 14 shows a reference phase versus received phase according to one embodiment.

FIG. 15 shows an enlarged view of FIG. 14.

FIG. 16 shows a reference frequency versus received frequency according to one embodiment.

FIG. 17 shows an enlarged view of FIG. 16.

FIG. 18 shows a cross correlation of reference and received signals.

FIG. 19 shows a cross correlation with a signal received at 25 dB of SNR according to one embodiment.

FIG. 20 depicts a distribution of timing estimation for 400 received packets at 25 dB SNR according to one embodiment.

FIG. 21 shows a standard deviation of the difference between the reference signal and the received signal according to one embodiment.

FIG. 22 shows an attacker disposed between a victim transmitter and a victim receiver according to one embodiment.

FIG. 23 shows GFSK frequency versus delayed GFSK frequency according to one embodiment.

FIG. 24 shows a difference in frequency versus 10 and 30 ns delayed signals according to one embodiment.

FIG. 25 shows an instantaneous frequency of an Rx signal resulting from addition of two similar frequency sine waves that are initially in phase (+15 kHz carrier).

FIG. 26 shows an instantaneous frequency of an Rx signal resulting from addition of two similar frequency sine waves that are initially in phase (−15 kHz carrier).

FIG. 27 shows an instantaneous frequency of an Rx signal resulting from addition of two similar frequency sine waves that are initially in phase (−15 kHz carrier), where the delays are controlled, according to one embodiment.

FIG. 28 shows normalized instantaneous frequency and envelope of an Rx signal resulting from addition of two similar frequency sine waves that are initially in phase (−15 kHz carrier), where the delays are controlled, according to one embodiment.

FIG. 29 depicts an attacker disposed of between a victim transmitter and a victim receiver according to one embodiment.

FIG. 30 depicts an attacker disposed of between a victim transmitter and a victim receiver according to one embodiment.

FIG. 31 shows phase rotation by frequency, with X as frequency in Hz, and with Y provided as unwrapped phase in radians, according to one embodiment.

FIG. 32A shows a magnitude of phase exchange by frequency, with X as frequency in Hz, and with Y provided as an IQ magnitude, according to one embodiment.

FIG. 32B shows a timing estimation of a GFSK signal, with X as frequency in Hz, Y as a timing estimate in ns where negative numbers are time advances, according to one embodiment.

FIG. 33 shows a received legitimate phase versus an attacked signal phase according to one embodiment.

FIG. 34 shows a legitimate received frequency versus an attacked frequency according to one embodiment.

FIG. 35 shows frequency peak locations for a legitimate received signal versus an attacked frequency signal according to one embodiment.

FIG. 36 depicts frequency peak locations for a legitimate received signal versus an attacked frequency signal using alternative less aggressive attack settings according to one embodiment.

FIG. 37 shows a received legitimate phase versus an attack signal phase using alternative settings.

FIG. 38 shows a tone followed by modulated data according to one embodiment.

FIG. 39 shows time aligning a corrected model signal and subtracting the aligned model from the received signal to check for coherency with respect to a tone according to one embodiment.

FIG. 40 shows a corrected reference signal time aligned and subtracted from an attacked signal according to one embodiment.

### DETAILED DESCRIPTION

A system and method provided for detecting or mitigating distance attacks against real-time location systems for determining a position of a remote device relative to an object or device. The system and method may utilize phase coherency in conjunction with a time of arrival estimate as a basis for detecting or mitigating distance attacks.

### I. Location System Overview

A system and method for determining location information of a remote device relative to an object based on a phase-based range is provided. The system and method may determine a location of the remote device based on a phase-based range for first communications between a first object device (e.g., a sensor [also described as an anchor]) and the remote device and a phase-based range for the first communications monitored by a second object device (e.g., a sensor [also described as an anchor]). A clock difference may be determined between the first device and the second device, and the clock difference may form the basis for a phase-based range determination for the first communications monitored by the second object device. The clock difference may be determined repeatedly. The phase-based range may be based on a signal characteristic of communication determined with respect to the first communications, such as a determined phase rotation of the first communications between the remote device and the first object device and a determined phase rotation of the first communications between the remote device and the second object device.

The object in one embodiment may be mobile, such that its environment may change depending on the location of the object. For instance, in the case of the object being a vehicle, the vehicle may be stored in an enclosed garage with a movable barrier at night, and then driven to and parked in an open-air parking lot, with one or more other vehicles in proximity thereto. The environmental configuration of these locations can vary in significant ways relative to RF or wireless communications, and the environmental configuration may vary in time even when the object is not moving relative to the environment. Such changes in the environment, as well as possible additional factors, may affect a clock difference between the first device and the second device relative to wireless communications. Additional examples of a system with adapting for environmental conditions is described in U.S. Pat. No. 10,869,161, entitled SYSTEM AND METHOD OF DETERMINING REAL-TIME LOCATION, issued Dec. 15, 2020, to Smith.

In one embodiment, a locator may be provided to determine the location information about the remote device relative to the object based on a signal characteristic of communications with the remote device. It should be understood that the present disclosure is not limited to determining the location information based on a single signal characteristic of communications; one or more additional signal characteristics of the communications may be used as a basis by the locator to determine the location information. For instance, as discussed herein, a time of arrival may be estimated based on modulated data in communications between the remote device and a device associated with the object.

A locator 310, as depicted in FIG. 4, may include a core function 312 operable in conjunction with one or more parameters 314 to determine the location information based on one or more inputs 316, such as at least one signal characteristic of wireless communications, and to generate one or more outputs 318 indicative of a location of the remote device 20 relative to the object 10. The values of the one or more parameters may be selected to yield location information for the remote device relative to the object with a degree of confidence for a given environment. For instance, the locator 310 may be configured to determine the location of the remote device relative to the object in an open-air parking lot with no vehicles in proximity thereto or within 4 inches with a degree of confidence of 90% or better. In one embodiment, selecting the values of the one or more parameters may be based on empirical analysis, including obtaining truth data pertaining to an actual location of the remote device relative to the object along with, for each actual location, at least one sample of at least one signal characteristic. As discussed herein, the system may include a plurality of object devices disposed at different locations on the object, such that a plurality of signal characteristics of the wireless communications can be obtained with respect to different positions on the object. The plurality of signal characteristics may be correlated with truth data pertaining to an actual location of the remote device relative to the object, and one or more parameters in conjunction with the core location function may be trained or selected to yield location information that approximates the truth data within a degree of confidence.

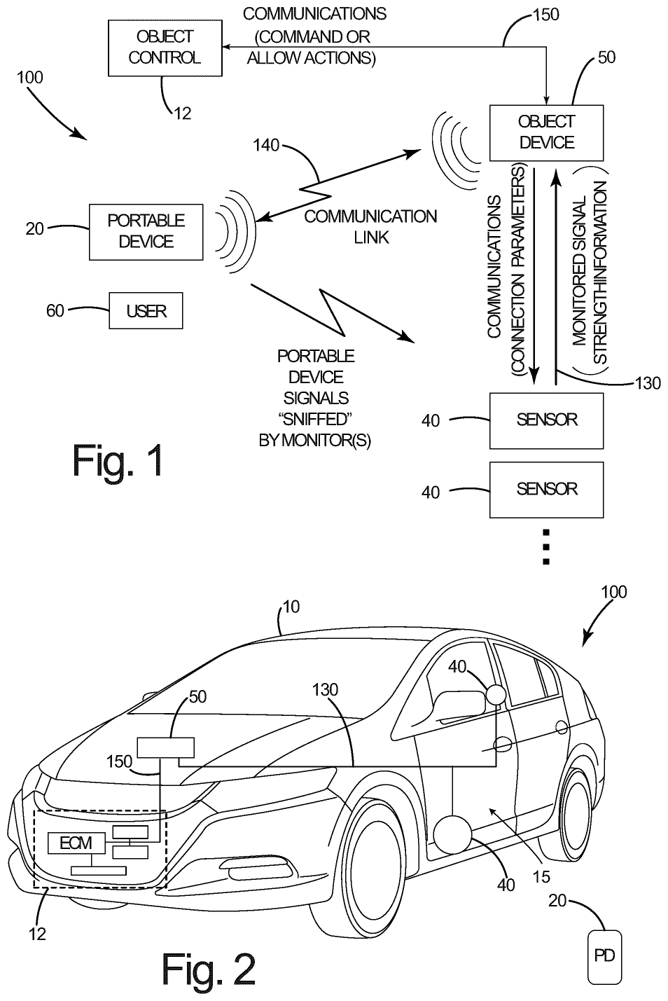

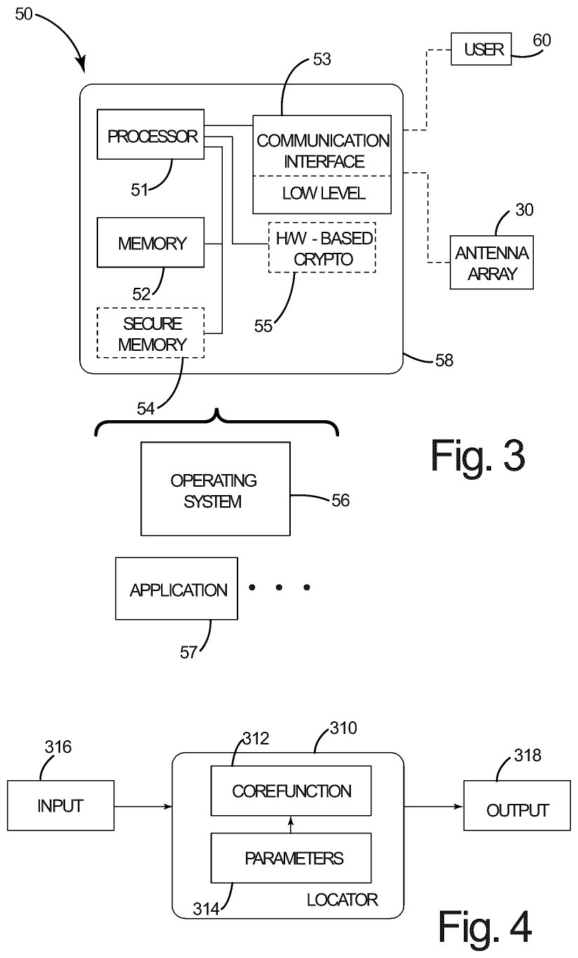

A system in accordance with one embodiment is shown in the illustrated embodiment of FIGS. 1, 2, and 5 and generally designated 100. The system 100 may include one or more system components as outlined herein. A system component may be a user 60 or an electronic system component, which may be the remote device 20, a sensor 40, or an object device 50, or a component including one or more aspects of these devices. The underlying components of the object device 50, as discussed herein, may be configured to operate in conjunction with any one or more of these devices. In this sense, in one embodiment, there may be several aspects or features common among the remote device 20, the sensor 40, and the object device 50. The features described in connection with the object device 50 depicted in FIG. 3 may be incorporated into the remote device 20 or the sensor 40, or both. In one embodiment, the object device 50 may form an equipment component disposed on an object 10, such as a vehicle or a building. The object device 50 may be communicatively coupled to one or more systems of the object 10 to control operation of the object 10, to transmit information to the one or more systems of the object 10, or to receive information from the one or more systems of the object 10, or a combination thereof. For instance, the object 10 may include an object controller 12 configured to control operation of the object 10. The object 10 may include one or more communication networks, wired or wireless, that facilitate communication between the object controller 12 and the object device 50. The communication network for facilitating communications between the object device 50 and the object controller 12 is designated 150 in the illustrated embodiment of FIGS. 1 and 2 and provided as a CAN bus; however, it is to be understood that the communication network is not so limited. The communication network may be any type of network, including a wired or wireless network, or a combination of two or more types of networks.

In the illustrated embodiment of FIG. 3, the object device 50 may include a control system or controller 58 configured to control operation of the object device 50 in accordance with the one or more functions and algorithms discussed herein, or aspects thereof. The system components, such as the remote device 20 or the sensor 40, or both, may similarly include a controller 58.

The controller 58 may include electrical circuitry and components to carry out the functions and algorithms described herein. Generally speaking, the controller 58 may include one or more microcontrollers, microprocessors, and/or other programmable electronics that are programmed to carry out the functions described herein. The controller 58 may additionally or alternatively include other electronic components that are programmed to carry out the functions described herein, or that support the microcontrollers, microprocessors, and/or other electronics. The other electronic components include, but are not limited to, one or more field programmable gate arrays, systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the object device 50, or they may reside in a common location within the object device 50. When physically distributed, the components may communicate using any suitable serial or parallel communication protocol, such as, but not limited to, CAN, LIN, Vehicle Area Network (VAN), FireWire, I2C, RS-232, RS-485, and Universal Serial Bus (USB).

As described herein, the terms locator, module, model, detector, and generator designate parts of the controller 58. For instance, a model or locator in one embodiment is described as having one or more core functions and one or more parameters that affect output of the one or more core functions. Aspects of the model or locator or detector may be stored in memory of the controller 58, and may also form part of the controller configuration such that the model is part of the controller 58 that is configured to operate to receive and translate one or more inputs and to output one or more outputs. Likewise, a module or a detector or locator are parts of the controller 58 such that the controller 58 is configured to receive an input described in conjunction with a module or detector or locator and provide an output corresponding to an algorithm associated with the module or generator or locator.

The controller 58 of the object device 50 in the illustrated embodiment of FIG. 3 may include one or more processors 51 that execute one or more applications 57 (software and/or includes firmware), one or more memory units 52 (e.g., RAM and/or ROM), and one or more communication interfaces 53, amongst other electronic hardware. The object device 50 may or may not have an operating system 56 that controls access to lower-level devices/electronics via a communication interface 53. The object device 50 may or may not have hardware-based cryptography units 55—in their absence, cryptographic functions may be performed in software. The object device 50 may or may not have (or have access to) secure memory units 54 (e.g., a secure element or a hardware security module (HSM)). Optional components and communication paths are shown in phantom lines in the illustrated embodiment.

The controller 58 in the illustrated embodiment of FIG. 3 is not dependent upon the presence of a secure memory unit 54 in any component. In the optional absence of a secure memory unit 54, data that may otherwise be stored in the secure memory unit 54 (e.g., private and/or secret keys) may be encrypted at rest. Both software-based and hardware-based mitigations may be utilized to substantially prevent access to such data, as well as substantially prevent or detect, or both, overall system component compromise. Examples of such mitigation features include implementing physical obstructions or shields, disabling JTAG and other ports, hardening software interfaces to eliminate attack vectors, using trusted execution environments (e.g., hardware or software, or both), and detecting operating system root access or compromise.

For purposes of disclosure, being secure is generally considered as being confidential (encrypted), authenticated, and integrity-verified. It should be understood, however, that the present disclosure is not so limited, and that the term “secure” may be a subset of these aspects or may include additional aspects related to data security.

The communication interface 53 may be any type of communication link, including any of the types of communication links describe herein, including wired or wireless. The communication interface 53 may facilitate external or internal, or both, communications. For instance, the communication interface 53 may be coupled to or incorporate the antenna array 30. The antenna array 30 may include one or more antennas configured to facilitate wireless communications, including Bluetooth Low Energy (BTLE) communications.

As another example, the communication interface 53 may provide a wireless communication link with another system component in the form of the remote device 20, such as wireless communications according to the Wi-Fi standard. In another example, the communication interface 53 may be configured to communicate with an object controller 12 of a vehicle (e.g., a vehicle component) via a wired link such as a CAN-based wired network that facilitates communication between a plurality of devices. The communication interface 53 in one embodiment may include a display and/or input interface for communicating information to and/or receiving information from the user 60.

In one embodiment, the object device 50 may be configured to communicate with one or more auxiliary devices other than another object device 50 or a user. The auxiliary device may be configured differently from the object device 50—e.g., the auxiliary device may not include a processor 51, and instead, may include at least one direct connection and/or a communication interface for transmission or receipt, or both, of information with the object device 50. For instance, the auxiliary device may be a solenoid that accepts an input from the object device 50, or the auxiliary device may be a sensor (e.g., a proximity sensor) that provides analog and/or digital feedback to the object device 50.

The system 100 in the illustrated embodiment may be configured to determine location information in real-time with respect to the remote device 20. In the illustrated embodiment of FIGS. 1, 2, and 5, the user 60 may carry the remote device 20 (e.g., a smartphone). The system 100 may facilitate locating the remote device 20 with respect to the object 10 (e.g., a vehicle) in real-time with sufficient precision to determine whether the user 60 is located at a position at which access to the object 10 or permission for an object command should be granted.

For instance, in an embodiment where the object 10 is a vehicle, the system 100 may facilitate determining whether the remote device 20 is outside the vehicle but in close proximity, such as within 5 feet, 3 feet, or 2 feet or less, to the driver-side door 15. This determination may form the basis for identifying whether the system 100 should unlock the vehicle. On the other hand, if the system 100 determines the remote device 20 is outside the vehicle and not in close proximity to the driver-side door (e.g., outside the range of 2 feet, 3 feet, or 5 feet), the system 100 may determine to lock the driver-side door. As another example, if the system 100 determines the remote device 20 is in close proximity to the driver-side seat but not in proximity to the passenger seat or the rear seat, the system 100 may determine to enable mobilization of the vehicle. Conversely, if the remote device 20 is determined to be outside close proximity to the driver-side seat, the system 100 may determine to immobilize or maintain immobilization of the vehicle.

The object 10 may include multiple object devices 50 or variant thereof, such as an object device 50 including a sensor 40 coupled to an antenna array 30, in accordance with one or more embodiments described herein.

Micro-location of the remote device 20 may be determined in a variety of ways, such as using information obtained from a global positioning system, one or more signal characteristics of communications from the remote device 20, and one or more sensors (e.g., a proximity sensor, a limit switch, or a visual sensor), or a combination thereof. An example of microlocation techniques for which the system 100 can be configured are disclosed in U.S. Nonprovisional patent application Ser. No. 15/488,136 to Raymond Michael Stitt et al., entitled SYSTEM AND METHOD FOR ESTABLISHING REAL-TIME LOCATION, filed Apr. 14, 2017—the disclosure of which is hereby incorporated by reference in its entirety.

In one embodiment, in the illustrated embodiment of FIGS. 1-5, the object device 50 (e.g., a system control module (SCM)) and a plurality of sensors 40 (coupled to an antenna array 30 as shown in FIG. 3) may be disposed on or in a fixed position relative to the object 10. Example use cases of the object 10 include the vehicle identified in the prior example, or a building for which access is controlled by the object device 50.

The remote device 20 may communicate wirelessly with the object device 50 via a communication link 140. The plurality of sensors 40 may be configured to monitor (e.g., sniff) the communications of the communication link 140 between the remote device 20 and the object device 50 to determine one or more signal characteristics of the communications, such as a phase characteristic, a signal strength, a time of arrival, a time of flight, or an angle of arrival, or a combination thereof. The determined signal characteristics may be communicated or analyzed and then communicated to the object device 50 via a communication link 130 separate from the communication link between the remote devices 20 and the object device 50. Additionally, or alternatively, the remote device 20 may establish a direct communication link with one or more of the sensors 40, and the one or more signal characteristics may be determined based on this direct communication link.

The one or more sensors 40 may be disposed in a variety of positions on the object 10, such as the positions described herein, including for instance, one or more sensors 40 in the door panel and one or more other sensors in the B pillar.

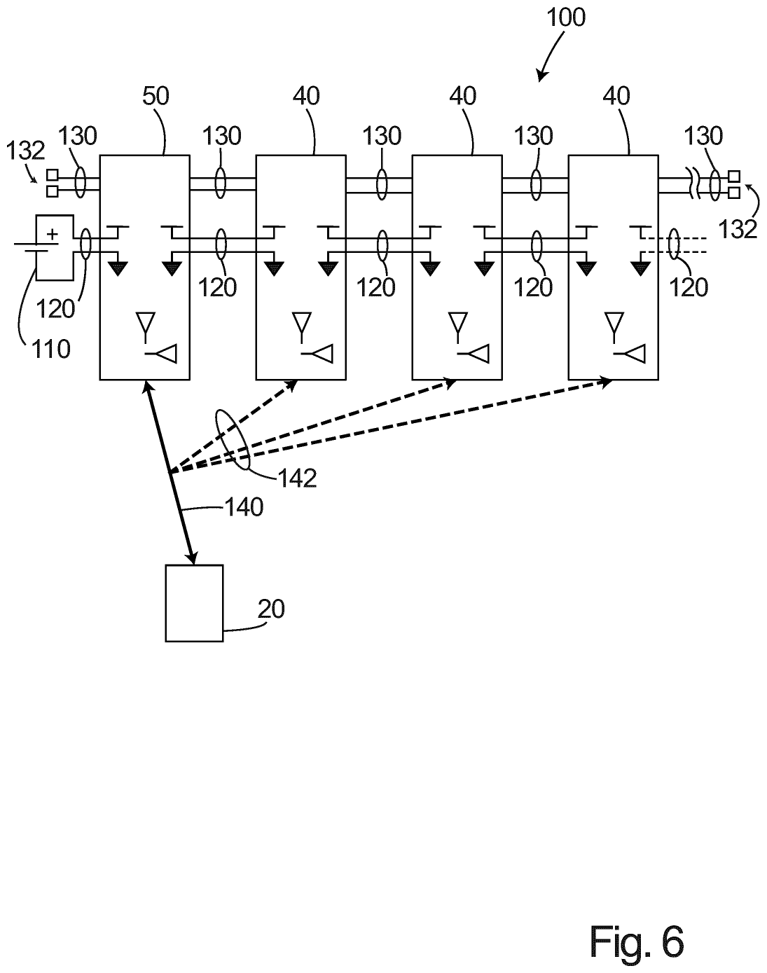

The object device 50 and the one or more sensors 40 may be powered via a power bus 120. The power bus 120 may be daisy chained from one device to the next as depicted in the illustrated embodiment of FIG. 6. Alternatively, the power bus 120 may be provided in the form of a star connection with power being supplied from one location to multiple locations via separate connections. Power supply and associated architecture is not limited to any one type—for instance, power may be distributed via both daisy chain and star connection configurations. The power bus 120 may be coupled to a power supply 110 to facilitate distributing power to devices in the system 100.

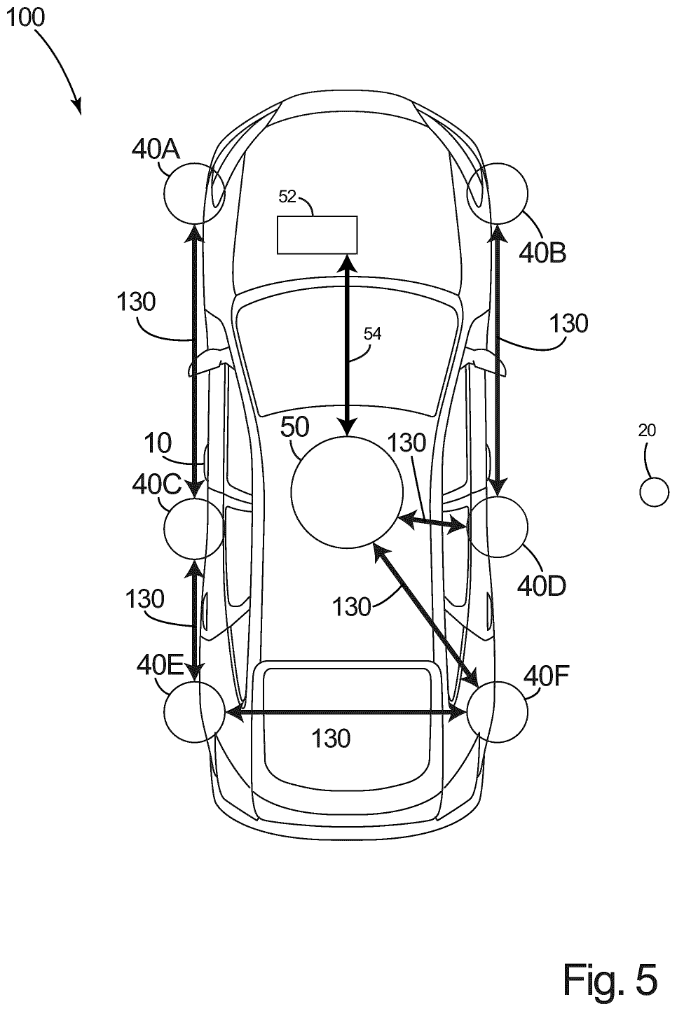

The system 100 in the illustrated embodiment may be configured to determine location information in real-time with respect to the remote device 20. In the illustrated embodiment of FIG. 5, a user may carry the remote device 20 (e.g., a smartphone). The system 100 may facilitate locating the remote device 20 with respect to the object 10 (e.g., a vehicle) in real-time with sufficient precision to determine whether the user is located at a position at which access to the object 10 or permission for an object 10 command should be granted.

In the illustrated embodiment of FIG. 6, the communication link 130 is distributed from one device to another and includes a terminator 132 at each end. The communication link 130 among the devices may be a shared link or a separate link for each device, or a combination thereof. For instance, the communication link 130 may be shared among two or more devices as depicted, and additionally or alternatively, the communication link 130 may be established separately from one device to another device. A device may communicate via more than one separate communications link 130, and may be configured to relay communications from one communication link 130 to another communication link 130.

The remote device 20 may communicate wirelessly with the object device 50 via a communication link 140, such as a BLE communication link or an Ultra-Wideband (UWB) communication link. The plurality of sensors 40 may be configured to monitor (sniff) the communications of the communication link 140 between the remote device 20 and the object device 50 as shown in phantom lines 142. The monitored communications or transmissions may correspond to a tone exchange (one-way or two-way) between the object device 50 and the remote device 20. Based on the monitored communications, a sensor 40 may determine one or more signal characteristics of the communications as described herein, including a phase characteristic of the communications. Additional or alternative signal characteristics include a signal strength, time of arrival, time of flight, angle of arrival, or a combination thereof. The determined signal characteristics may be communicated or analyzed and then communicated to the object device 50 via the communication link 130 separate from the communication link 140 between the remote device 20 and the object device 50.

Additionally, or alternatively, as described herein, the remote device 20 may establish a direct communication link with one or more of the sensors 40, and the one or more signal characteristics may be determined based on this direct communication link. For instance, as described herein, the remote device 20 and a sensor 40 may perform a tone exchange as a basis for determining a distance between the sensor 40 and the remote device 20, and the remote device 20 and the sensor 40 may communicate modulated data that forms the basis for a time of arrival determination. The direct communication link may be established according to the BLE protocol; however, the present disclosure is not so limited—the direct communication link may be any type of link or links, including Ultra-Wideband (UWB).

It is to be understood that an object 10, such as a vehicle, may include a number of sensors 40 (A-F) that can be greater than or less than the number shown in the illustrated embodiment of FIG. 5. Depending on the implementation, some number of sensors 40 may be integrated in a vehicle.

As described herein, one or more signal characteristics, such as a phase characteristic, a signal strength, time of arrival, time of flight, and angle of arrival, may be analyzed to determine location information about the remote device 20 relative to the object 10, as an aspect of the object 10, or the object device 50, or a combination thereof. For instance, a phase rotation of a tone transmission, and optional re-transmission, or a phase characteristic indicative of a phase rotation may form the basis for determining a distance between an object device 50 or a sensor 40 and the remote device 20. Additional examples of signal characteristics include time difference of arrival or the angle of arrival, or both, among the sensors 40 and the object device 50 may be processed to determine a relative position of the remote device 20. The positions of the one or more antenna arrays 30 relative to the object device 50 may be known so that the relative position of the remote device 20 can be translated to an absolute position with respect to the antenna arrays 30 and the object device 50.

Additional or alternative types of signal characteristics may be obtained to facilitate determining position according to one or more algorithms, including a distance function, trilateration function, a triangulation function, a lateration function, a multilateration function, a fingerprinting function, a differential function, a time of flight function, a time of arrival function, a time difference of arrival function, an angle of departure function, a geometric function, or any combination thereof.

### II. System Device Overview

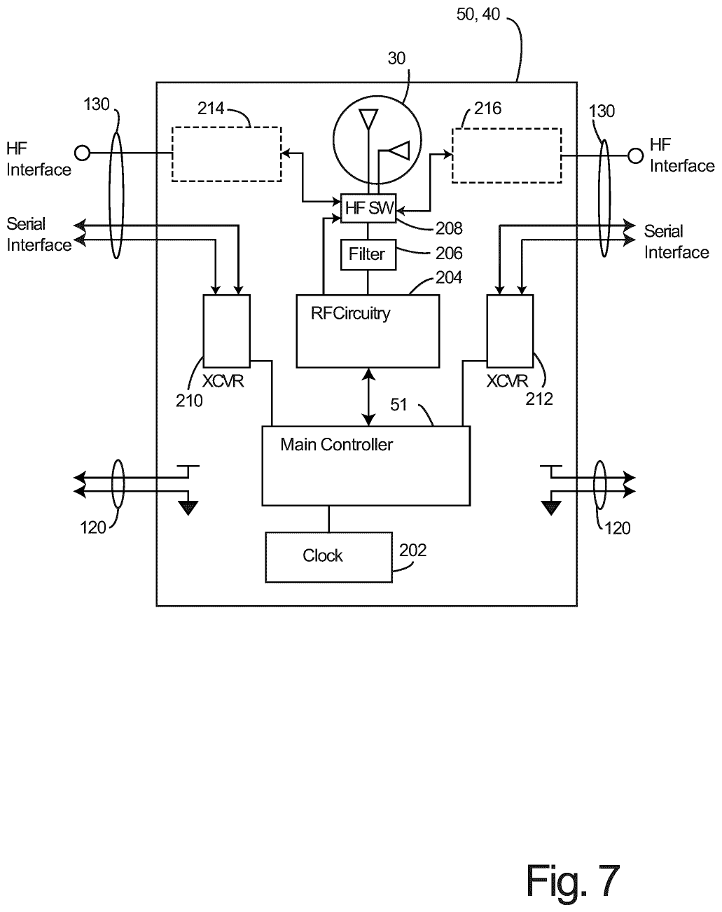

In the illustrated embodiment of FIG. 7, the object device 50 in one aspect is shown in further detail. The structure and configuration of the object device 50 described in conjunction with FIG. 7 may be incorporated into a sensor 40 or any other device described herein, such as a remote device 20—but for purposes of disclosure, the structure and configurations described in conjunction with the object device 50.

The object device 50 in the illustrated embodiment of FIG. 7 includes several components, one or more of which may be provided in a commercial embodiment. The object device 50 in some instances may be described as an anchor disposed on the object 10.

The object device 50 may include RF circuitry 204 operable to control transmission and reception of HF signals. The RF circuitry 204 may be operably coupled to an antenna array 30, which may include one or more antennas. An example configuration of an antenna array 30 is described in U.S. Nonprovisional patent application Ser. No. 18/096,666 to Osman Ahmed et al., entitled SYSTEM AND METHOD FOR COMMUNICATING, filed Jan. 13, 2023—the disclosure of which is incorporated herein by reference in its entirety.

The RF circuitry 204 may be configured to supply or receive high-frequency signals from the antenna array 30 via filter circuitry 206 and a HF switch 208. The filter circuitry 206 may condition the signal output from the RF circuitry 204 for driving the antenna array 30. Conversely, the filter circuitry 206 may condition a signal received from the antenna array 30 for processing by the RF circuitry 204. The HF switch 208 may selectively direct input and output of HF signals, including HF supplied to and received from the antenna array 30.

In one embodiment, the RF circuitry 204 may be configured according to one embodiment to transmit and receive signals via a high-frequency interface of the communication link 130. Transmission and reception of HF signals in one embodiment may enable an object device 50 to communicate via a physical medium according to a communication protocol that is the same or similar to the one utilized by the antenna array 30 in the RF circuitry 204. For instance, the object device 50 may transmit and receive communications via a physical medium defined by the high-frequency interface that correspond to the BTLE communications, while also transmitting and receiving communications via the antenna array 30 that correspond to BTLE communications.

The HF switch 208 may selectively direct output from the RF circuitry 204 to the high-frequency interface of the communication link 130, and selectively direct input from the high-frequency interface of the communication link 130 to the RF circuitry 204. In one embodiment, the HF interface may be a single ended configuration, such as a coaxial conductor arrangement. Alternatively, the HF interface may be differential, and optionally include conditioning circuitry 214, 216 (e.g., a balun and/or an impedance transformer) for translating between a single ended output from the HF switch 208 and a differential output of the high-frequency interface of the communication link 130.

In one embodiment, the high frequency switch 208 and the conditioning circuitry 214, 216 may be absent, such that the communication link 130 is provided via a serial interface or another type of communication interface, as described herein.

In the illustrated embodiment, the object device 50 is configured to transmit and receive communications via separate high-frequency interfaces provided by separate communication links 130. In other words, the two communication links 130 in the illustrated embodiment are isolated from each other, such that communications received on one communication link 130 are not inherently transmitted or seen on the other communication link 130. As discussed herein, the object device 50 may be configured to relay communications from one of the communication links 130 to the other of the communication links 130. For example, communications received via one high-frequency interface may be directed to the RF circuitry 204, and may be related to the other high-frequency interface via the RF circuitry 204. The HF switch 208 may be configured to transition from one state to another state to facilitate relaying of such communications. It is to be understood, however, that in one or more embodiments described herein, communications transmitted via one of the communication links 130 may inherently pass to the other of the communication links 130.

The object device 50 may include a main controller 51, which may correspond to the controller 58, and may be configured to direct operation of the RF circuitry 204, as described herein. In one embodiment, the main controller 51 may control a tone exchange via the antenna array 30 to facilitate determining a one-way range or two-way range determination with respect to the remote device 20. Additionally, or alternatively, the object device 50 may sniff communications that pertain to a tone exchange and that occur between another object device (e.g., a sensor 40) and the remote device 20. In one embodiment, a sensor 40 may be configured to monitor or sniff communications that pertain to a tone exchange and that occur between the object device 50 and the remote device 20.

The main controller 51 may further direct transmission and reception of communications via the HF interface of the one or more communication links 130. As an example, the main controller 51 may direct transmission and reception of BTLE communications via the HF interface of the communication link 130. Information transmitted via the high-frequency interface of the communication links 130 may relate to one or more signal characteristics obtained with respect to communications received and/or transmitted via the antenna array 30. As an example, the information transmitted via the communication link 130 may be indicative of a phase rotation determined with respect to communications received and/or transmitted via the antenna array 30.

Additionally, or alternatively, the main controller 51 may utilize the high-frequency interface of the communication links 130 for time synchronization or time offset determination purposes. As discussed herein, a phase characteristic of a tone exchange is based at least in part on a time reference of the device. And because time is translatable to distance (and conversely distance to time) with respect to electromagnetic waves, determining the reference time of the sensor 40 may facilitate enhancing accuracy with respect to determining the phase characteristic and distance between the remote device 20 and the object device 50.

The object device 50 may include a clock 202 that operates an oscillator for the sensor 40 and generates one or more timing signals for operation of aspects of the object device 50, including the main controller 51 and the RF circuitry 204. In one embodiment, the clock 202 may be configured to generate a timing signal that the main controller 51 and/or the RF circuitry 204 may use as a basis for transmitting a tone exchange signal (e.g., an initiator signal). As described herein, the tone exchange signal may include transmissions according to a plurality of frequencies and a phase rotation with respect to such transmissions and may form the basis for a distance determination with respect to the object device 50 and the remote device 20.

In one embodiment, the object device 50 includes first and second transceivers 210, 212 coupled respectively to serial interfaces of the communication links 130. The transceivers 210, 212 may be CAN transceivers, but the present disclosure is not so limited. The transceivers 210, 212 may facilitate any type of serial or non-serial communications via the communication links 130, including but not limited to RS-485, LIN, Vehicle Area Network (VAN), Fire Wire, I2C, RS-232, RS-485, and Universal Serial Bus (USB).

The first and second transceivers 210, 212 may enable communications among devices (e.g., the object device 50 and a sensor 40). For instance, the object device 50 may transmit to a sensor 40, via the serial interface of the communication link 130, connection parameters for the communication link 140 to enable the sensor 40 to monitor communications between the object device 50 and the remote device 20. A sensor 40 may receive such communications via the first transceiver 210 and relay the communications to another device (e.g., another sensor 40) via the second transceiver 212.

Optionally, the object device 50 may include a communication link 130 configured with a serial interface without the high-frequency interface or a high-frequency interface without the serial interface. Communications described herein with respect to one interface and not the other may be communicated via the interface provided by the communication link 130. For instance, the communication link 130 may include a high-frequency interface without the serial interface, and communications described in connection with the serial interface may be transmitted via the high-frequency interface. The high frequency interface and/or the serial interface may be wired or wireless.

The communication interface of the main controller 51 may facilitate any type of communication link, including any of the types of communication links described herein, including wired or wireless. The communication interface may facilitate external or internal, or both, communications. For instance, the communication interface may be coupled to the RF circuitry 204 to enable communications via one or more of the antenna array 30 and the HF interface of the communication link 130.

As another example, the communication interface of the main controller 51 may facilitate a wireless communication link with another system component in the form of the remote device 20, such as wireless communications according to the Wi-Fi standard or UWB, or any combination thereof. As another example, the communication interface of the main controller 51 may include a display and/or input interface for communicating information to and/or receiving information from the user.

### III. Phase-based Ranging (PBR)

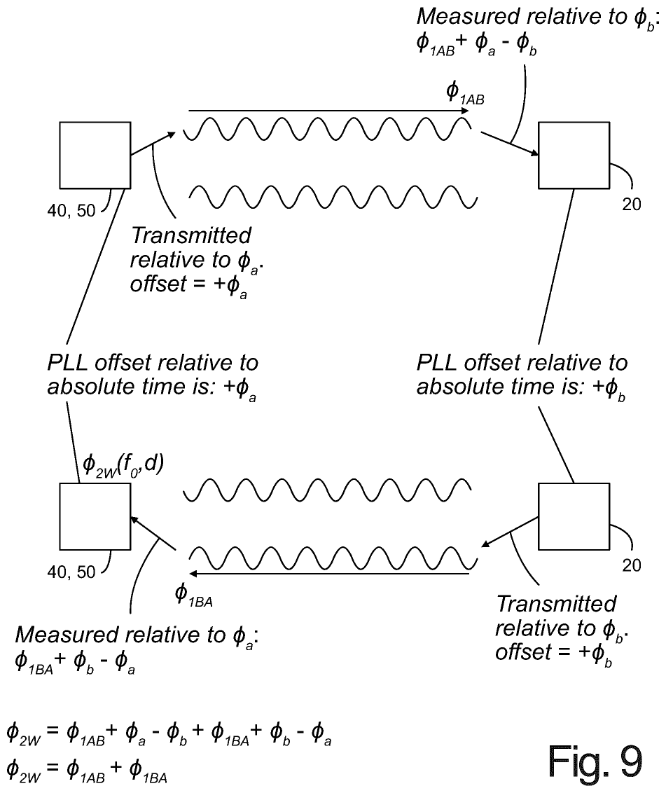

In the illustrated embodiment of FIG. 9, a tone exchange according to a plurality of frequencies f_0, f_1, f_2, f_3 is depicted with the object device 50 being the initiator or device A and the remote device 20 being a reflector or device B. It is noted that device A and/or device B may be different devices in the system 100. For instance, device A may be a sensor 40 and device B may be the remote device 20. As another example, device A may be an object device 50 and device B may be a sensor 40. In using different frequencies for the tone exchange, a type of channel sounding for ranging approach is utilized.

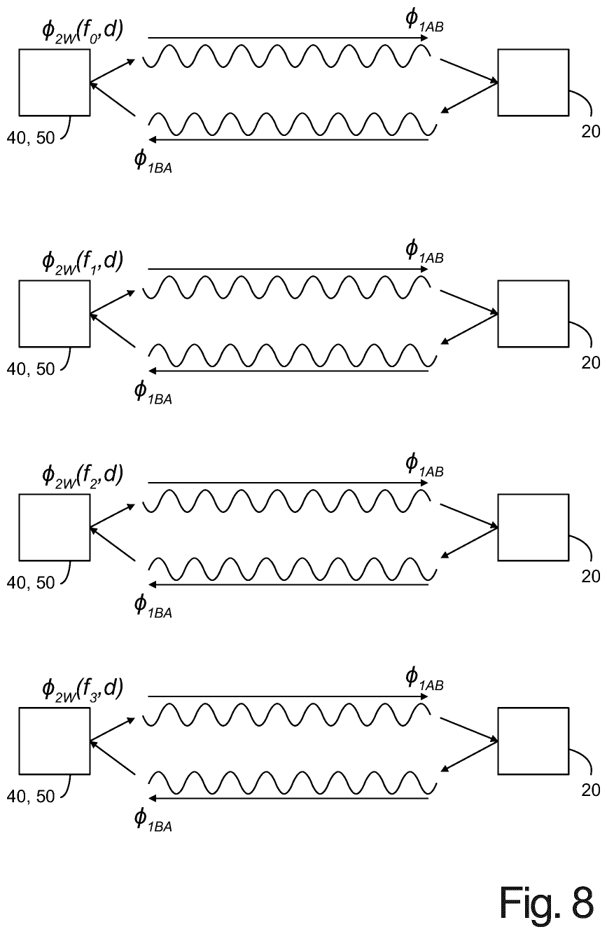

In FIG. 8, the tone exchange may involve device A transmitting an initiator signal according to a frequency, device B receiving the initiator signal, device B transmitting a reflector signal based on the initiator signal according to the same frequency, and device A receiving the reflector signal. Based on a phase characteristic of the initiator signal and/or the reflector signal measured respectively by the device B or device A, a phase rotation of the initiator signal and/or the reflector signal may be determined, enabling a distance determination with respect to device A and B.

A single tone exchange according to frequency f_0 is depicted in further detail in FIG. 9, and discussed in conjunction with one or more phase characteristics and related properties of the tone exchange. For purposes of this example, the frequency f_0 is identified as 2.4 GHz-however the frequency may vary. At this example frequency the wavelength of the signal is approximately 12.5 cm. By knowing the total phase rotation, there and back for the initiator and reflector signal, distance can be determined. For instance, if the total phase of a two-way exchange (ϕ_AB+ϕ_BA or ϕ_2 W) is measured as 90 deg. (¼ of a full rotation), the two-way distance can be determined as 12.5 cm*¼+12.5 cm*N, with N being the number of wraps or full rotations of the initiator and reflector signals.

If the tone exchange is conducted for a second frequency f_1, different from f_0, a different measured phase will result, and the wavelength will be different due to the change in frequency. The difference in measured phase coupled with the known frequency difference (f_1-f_0) may facilitate determining N, the number of wraps or full rotations of the initiator and reflector signals.

In the illustrated embodiment of FIG. 9, there may be an initial phase offset relative to a timing signal. This phase offset of device A as well as the phase offset of device B for a two-way exchange cancel out in determining a two-way phase rotation.

In the illustrated embodiment, the initiator (device A) transmits and receives with a relative phase offset of ϕa, and the reflector (device B) transmits and receives with a relative phase offset of ϕb. ϕa is the inherent phase offset of the initiator, and ϕb is the inherent phase offset of the reflector. The one-way phase rotation ϕ1 W=ϕ1AB, with the phase from A, measured at B, when ϕa and ϕb are 0 or the same, and the one-way phase rotation ϕ1 W=ϕ1BA, with the phase from A, measured at B, when ϕa and ϕb are 0 or the same. However, when the ϕa and ϕb are not the same, these offsets cause the measured phase at B and at A to be different. This is because, when going from A to B, ϕa causes A to transmit late and ϕb causes B to measure late. ϕ1ABmeasured=ϕ1AB+ϕa−ϕb, when going from B to A, ϕb causes B to transmit late and ϕa causes A to measure late, with ϕ1BAmeasured=ϕ1BA+ϕb−ϕa. When these are summed together, the two-way rotation can be determined as:

$$ϕ 2 W = ϕ 1 ABmeasured + ϕ 1 BAmeasured = ϕ 1 AB + ϕ a - ϕ b + ϕ 1 BA + ϕ b - ϕ a$$

It can be seen that ϕa and ϕb cancel out. Switching to the Euler notation yields the same result with the phase offsets cancelling when the exponents are combined, such that the two-rotation can be determined as:

$$Φ2 W = {e}^{j \frac{4 π fd}{c}}$$

The notation for determining one-way and two-way rotations can vary depending on documentation parameters and the method utilized for conceptualizing phase. For instance, phase can be described relative to the IQ domain, where I+Qj=X+Yj=Φ=cos (ϕ)+j sin (ϕ) e^{-ϕ}. Here, Φ, capital PHI, is the complex representation of the phase in radians or ϕ, lowercase phi. The Φ_1AB_measured value may be called the reflector Phase Correction Term (PCT), or PCT_B, while the Φ_1BA_measured value may be called PCT_A. The two-way rotation Φ2W=Φ1_AB_measured·Φ1_BA_measured.

Because the wavelength for high frequency transmissions can be short relative to the target distance being measured, the transmissions wrap or complete full phase rotations such that total phase rotation embodied as the total distance cannot be measured directly from a phase in the input stage of the RF circuitry 204. For instance, for a carrier frequency at 2.4 GHz, the phase rotation wraps around 2π with d in the range of 12 cm. A phase measurement in the input stage of the RF circuitry 204 may indicate a phase within the range 0−2π, but the phase measurement may not directly indicate the number of phase rotation wraps.

To measure longer distances without ambiguity, two different frequencies (f0, f1) can be used at two different instants i in time (i0, i1) to compute two different phases rotations. The two different phase rotations can be used to measure the distance. A phase-based distance determination is described in conjunction with two different frequencies—however, it is to be understood that phase measurements for a plurality of frequencies (including more than two frequencies) may be used to enhance accuracy of the distance determination.

In the case of utilizing two or more different frequencies (f_0, f_1) as a basis for determining distance, as depicted in FIG. 8, the initiator may conduct two tone exchanges to measure a two-way phase rotation (ϕ_2w) at the two frequencies (f_0, f_1). In this example, ϕ_2w (f_0, d)=ϕ_1AB (f_0,d)+ϕ_1BA (f_0, d), where the phase characteristic, ϕ_1AB (f_0, d) is measured in the initiator and the phase characteristic, ϕ_1BA (f_0, d) is measured in the reflector. And, ϕ_2w (f_1,d)=ϕ_1AB (f_1,d)+ϕ_1BA (f_1, d), where the phase characteristic, ¢_1AB (f_1, d) is measured in the initiator and the phase characteristic, ϕ_1BA (f_1, d) is measured in the reflector. The difference in the two-way phase measurements, ϕ_2w (f_0, d)−ϕ_2w (f_0, d), is related to the difference in frequency and distance as follows:

$$Δ {ϕ}_{2 W} = \frac{4 π d Δ f}{c} mod 2 π$$

Based on the difference in the two-way phase measurements, distance and time delay can be determined as follows:

$$d = \frac{c Δ {ϕ}_{2 W}}{4 π Δ f} mod \frac{c}{2 Δ f}$$

$$t = \frac{d}{c} = \frac{Δ {ϕ}_{2 W}}{4 π Δ f} mod \frac{1}{2 Δ f}$$

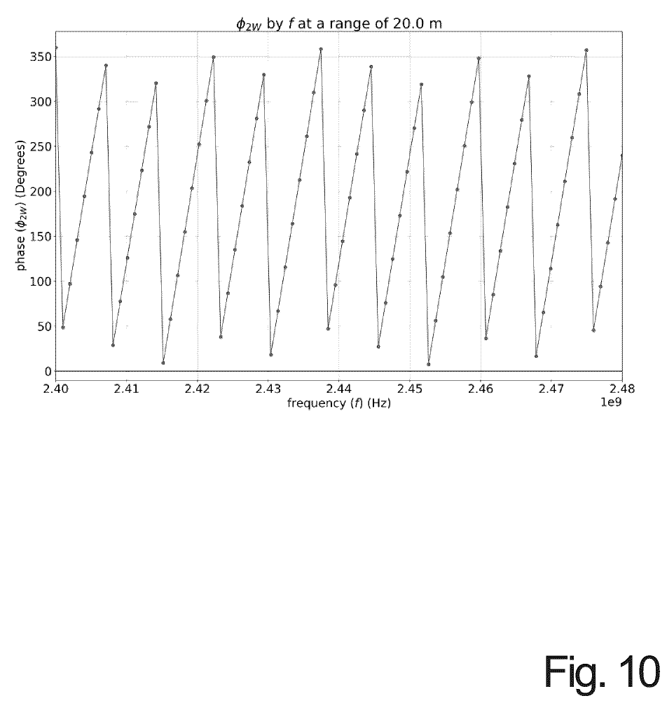

It is noted that from the relationship between two-way phase rotation, frequency, and distance, that the two-way phase rotation (ϕ_2w) wraps back to 0 with distance remaining constant and changing frequency. As a result, for multiple frequencies in a band (e.g., 2.4 GHz to 2.48 GHz), the two-way phase rotation may wrap back to 0 degrees zero or more times depending on the distance. The wrap distances for round trip or two-way phase rotation and a plurality of frequencies are depicted in the illustrated embodiments of FIG. 10. It can be seen specifically in FIG. 10 that, for a distance of 20 m, a 2.4 GHz to 2.48 GHz signal wraps at 1 MHz frequency steps. The slope of the two-way phase rotation may also depend on the distance. In one embodiment, distance may be determined based at least in part on the slope and/or the frequency at which the two-way phase rotation wraps.

The present disclosure is not limited to determining two-way phase rotation. The one-way phase rotation (ϕ_1w) may be conceptualized in a similar manner, with the distance and time delay being determined as follows:

$$d = \frac{c Δ {ϕ}_{1 W}}{2 π Δ f} mod \frac{c}{Δ f}$$

$$t = \frac{d}{c} = \frac{Δ {ϕ}_{1 W}}{2 π Δ f} mod \frac{1}{Δ f}$$

It is noted, however, that in order to obtain an accurate one-way ranging delta between the transmission phase and the reception phase, the initiator and the receiver may need to be synchronized in time. With two-way ranging, lack of synchronicity may not be necessary because differences in time bases for the two devices may cancel out.

### IV. Ranging Relative to Distance Attacks

In one embodiment, the system 100 may be configured to determine a distance or range between an object device 50 or sensor 40 and a remote device 20. In some circumstances, an attacker may attempt to conduct a distance attack with respect to this determination in order to obtain unauthorized access to an object or initiate an unauthorized action. In this configuration, the attacker may be disposed between a victim transmitter and a victim receiver, each of which may correspond to a component in the system 100 such as an object device 50 or sensor 40 and a remote device 20. For instance, the victim transmitter may be the remote device 20 and the victim receiver may be the sensor 40, or the victim transmitter may be the sensor 40 and the victim receiver may be the remote device 20.

### A. Reference Signal

Generically a reference signal is a mathematical description of the set of signals that is received or is expected to be received by the victim receiver. In secure ranging applications, the set of ranging symbols may be pre-agreed upon via some mechanism prior to each ranging packet. This may be achieved by both devices having a ranging key and each device agrees upon a counter associated with each packet. The ranging key and the counter are inputs into an algorithm to determine that each device runs to determine the symbols transmitted by the victim transmitter and which symbols are expected to be received by the victim receiver.

Therefore, the victim receiver may build a mathematical representation of the expected signal. The reference signal may be expressed as a time series of complex numbers which represent IQ measurements from the radio hardware. The IQ values can encode phase and amplitude; a progression of the time series can encode frequency.

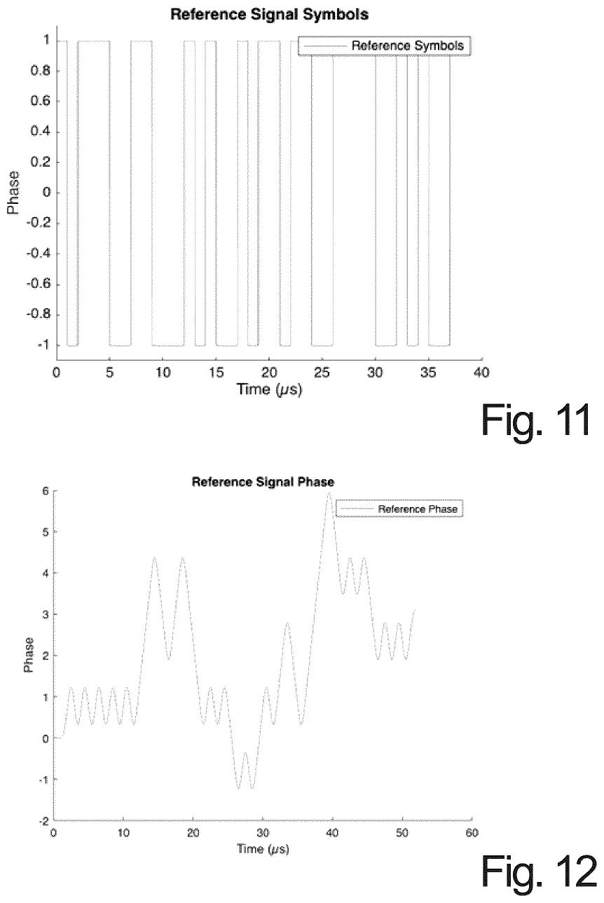

In the illustrated embodiment of FIG. 11, the binary (+1/−1) representation of the symbols that are transmitted by the victim receiver and are expected by the victim receiver are shown. The binary representation of the symbols is:
[1 0 1 1 1 0 0 1 1 0 0 0 1 0 1 0 0 1 1 0 1 1 1 1 0 0 1 0 1 0 0 1]

In one embodiment, the victim receiver may compute a series of complex numbers representing the expected signal to be received by the radio of the victim receiver. In the case of a GFSK signal, such as the signal defined by the Bluetooth SIG, the symbols from FIG. 11 may be multiplied by a factor based on the Modulation Index (MI), then filtered according to a Gaussian filter based upon the Bandwidth Time (BT) factor. The phase of the reference signal is proportional to the total accumulated frequency. However, other factors are included such as the addition of preamble and trailer symbols according to the protocol being implemented. Also, the ramp up behavior of the PLL is left unconstrained, which is described herein in further detail.

In the illustrated embodiment of FIG. 12, the result of converting the symbols in FIG. 11 to a complex IQ value is shown after adding the preamble and trailer then extracting the phase from it.

In FIG. 12, the reference signal starts at zero phase. The victim receiver may not receive the exact same phase as the reference signal because its Phase Locked Loop (PLL) is not phase aligned with the PLL of the victim transmitter, as well as there is a phase shift caused by the channel between the victim transmitter and victim receiver. It is this channel between the victim transmitter and victim receiver for which steps may be taken to ensure it is legitimate, without the presence of an attacker who is modifying the channel to attack the timing estimations.

There are other impairments as well that may prevent the victim receiver from receiving exactly the communications transmitted by the victim transmitter.

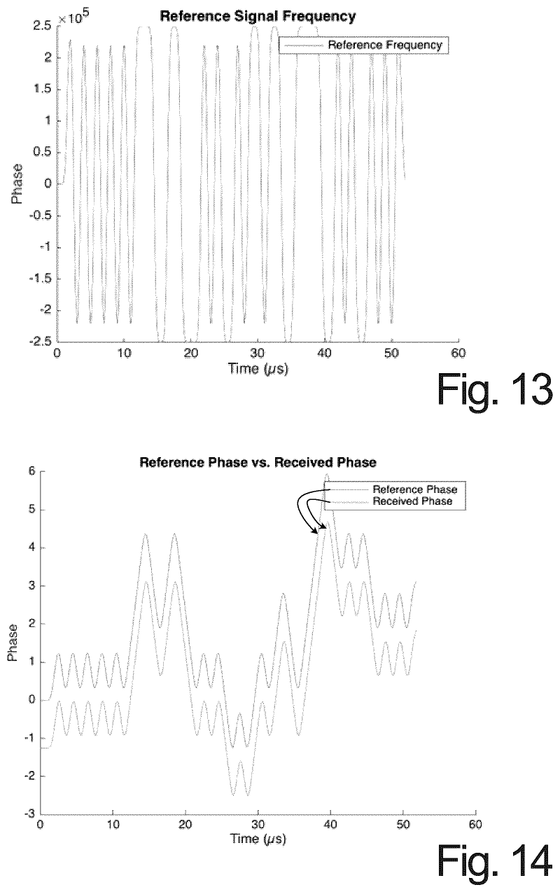

In the illustrated embodiment of FIG. 13, the reference signal has been converted to frequency.

### B. Timing Estimation

It is to be understood that there are many potential methods for performing timing estimation. It is not the intention of this disclosure to describe all methods of timing estimation, and in general a description of timing estimation is provided for purposes of disclosure and understanding. It is to be understood that additional or alternative methods of timing estimation are within the scope of this disclosure. For instance, other methods of timing estimation that are more efficient, more practical, and more robust against sources of measurement errors may exist, and it is to be understood that such methods may be utilized in conjunction with the systems and methodologies described herein.

In the illustrated embodiment of FIG. 14, the phase of the reference signal vs. the phase of a received signal that has been delayed 100 ns (about 30 meters of distance) is shown. The reference signal again starts with an initial phase of 0; whereas the received signal has a different phase, which the phase difference has contributions from the phase difference in phase between the transmitter and receiver, as well as the phase due to the channel.

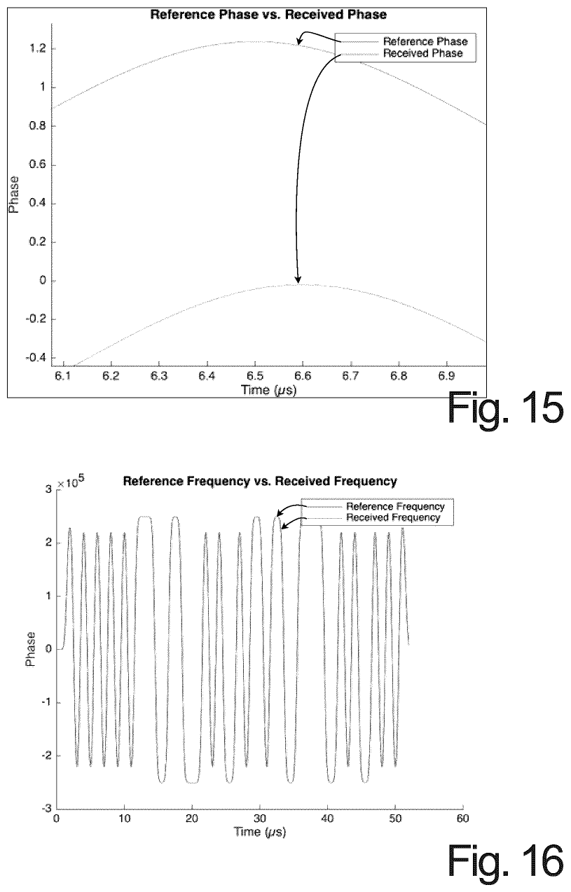

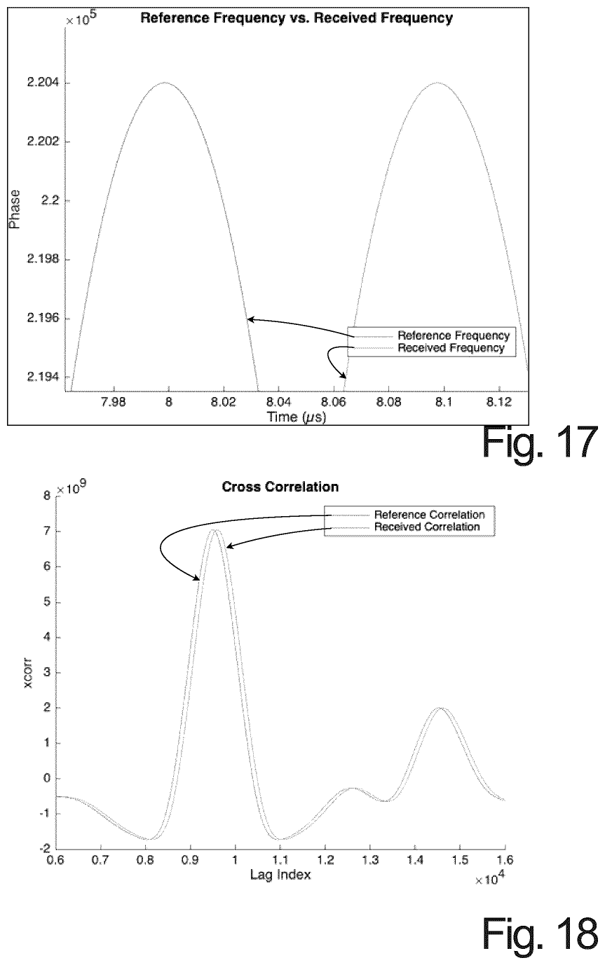

In the illustrated embodiment of FIG. 15, the 100 ns delay of phase maximum between the reference signal and the received signal is shown. An algorithm that detects the peaks may be employed to determine relative timing of the two signals.

In the illustrated embodiment of FIG. 6, the phase of the IQ values is converted into frequency. The signal is the GFSK signal encoding the symbols. By converting the frequency, which involves the differentiation of phase, the DC offset in phase between the phase of the reference signal vs. the phase of the received signal may be removed.

Turning to FIG. 7, by zooming in on frequency of the reference and received frequencies shown in FIG. 6, it can be seen that the peak frequency deviation is also delayed by 100 ns.

Using cross correlation of the signal in FIG. 11, the square wave representation of the symbols, against the frequency of both the reference signal and the received signals in FIG. 16, may provide time estimation. The difference in the correlation of peak indices is the number of time samples of delay difference there is between the reference signal and the received signal. FIG. 18 shows that the correlation contour of the reference signal and received signal are nearly identical; however, again the correlation peak of the received signal is slightly delayed compared to the reference signal. In FIG. 8, there is a 100 index difference between the two signals corresponding to the expected 100 ns.

To reiterate, this method to estimate timing is one of many possible methods. Correlation can be performed using phase, frequency, or other derived features. Peak interpolation can be used between sample values to provide higher resolution than the sampling rate. Any type of methodology may be utilized so that the receivers use a technique mathematically similar to this to estimate the time of arrival of a signal.

An attacker may attempt to make a wave form that has the appropriate shape to make the received signal appear earlier than it actually is.

### C. Signal Quality

It is to be understood that noise in the victim transmitter, noise in the victim receiver, and noise in the RF channel all may distort the received signal so that it is not a perfect match of a time delayed reference. Also, impairments in the IQ sampling engine, uncompensated frequency difference, errors in modulation index, and gaussian filtering shape may further distort the received signal relative to the reference. Also, other factors such as the distortion caused by the victim receiver's channel filter may be considered when building the reference. To the extent these impairments can be estimated, they may be incorporated into the reference signal. More on estimating impairments and updating the model is described herein.

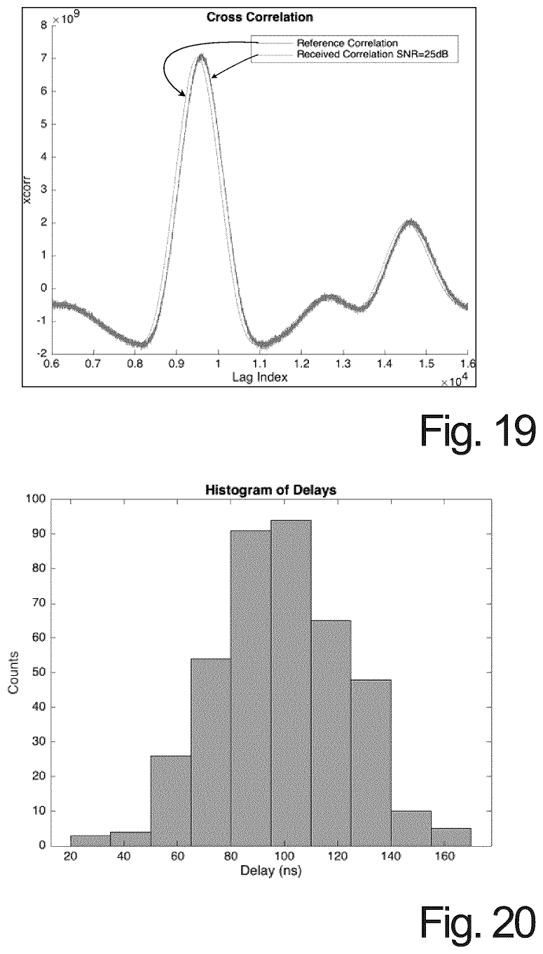

For instance, FIG. 19 shows the impact of receiving a signal with a Signal to Noise Ratio (SNR) of 25 dB. Twenty-five dB SNR is similar to what may be expected in a real channel due to environmental noise of various origins. The received signal is still visibly delayed compared to the blue reference signal; however, the exact peak of the correlation of the received signal has some ambiguity because of the noise. Repeated measurements may lead to slightly different timing estimations.

FIG. 20 depicts a histogram of timing estimations where 100 ns is the ground truth for 400 trials at 25 dB SNR. The mean value of timing estimation is close to the true value of 100; however, there is variation caused by the noise. Regardless of the timing estimation algorithm implementation, several measurements may be taken and inspected for their mean and spread, such as standard deviation or other metrics in order to determine if the series of measurements meet the security criteria set by the system. The criteria may be that the mean of the measurement is within some constrained range of expectation, that the standard deviation of the measurements is below some determined threshold, that there is no single measurement that deviates by an absolute value from the mean, or that the full range of measurements from min to max is within some determined range.

After the timing offset of the signal is determined, the reference signal may be aligned in time, and potentially in phase (if called for). Any known impairments may also be removed, such as residual frequency errors that may be present as trends in the phase progression of the received signal's IQ values. Each sample of the reference signal may be compared to the corresponding sample of the received signal. Any number of comparison techniques are possible, such as the Pearson correlation, or comparing the standard deviation of the difference between signals, either in phase or in frequency. The result is a numerical score that describes the similarity between the reference signal and the received signal. This numerical score may be referenced as the security metric. A threshold determined by the system for how closely matched the reference signal is to the received signal may be set to judge if the received signal has enough integrity to be used as a measurement. An attacker may seek to find a signal that has a desired shift in timing, that does not cause a significant distortion, and that may be detected by the security metric.

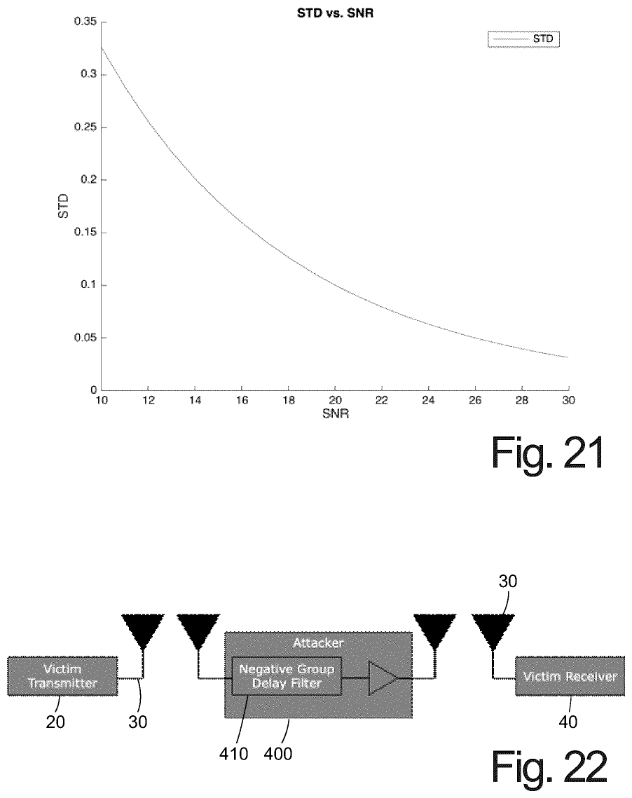

FIG. 21 shows an example of a security metric based on computing the difference in frequency between the reference signal and the received signal. As the SNR increases, the similarity between the reference signal and the received signal increases, and the standard deviation decreases. The system may set a threshold at maximum value for the standard deviation that is determined to be secure.

### D. Learning, Re-learning, Estimating and Removing Impairments

Some of the impairments are dynamic, such as the frequency error depending primarily upon the differences in clock frequency input into each PLL, which depends upon several factors, such as the temperature of each device. Therefore, the impairment of uncompensated frequency offset may be measured by taking a number of phase measurements of a signal at an expected frequency and calculating the phase progression relative to the receiver's local oscillator. Other factors, such as impairments in modulation index or gaussian filter shape of the transmitter may be relatively static and based on the design of the transmitter or process variations during manufacture of the transmitter. These parameters may be estimated by comparing the true signal from the transmitter to the ideal model signal, then adjusting the model parameters to best fit the true signal. Many techniques such as gradient descent may be used to enhance or optimize the model. The learning process may be initiated during initial set up/pairing of the devices. For instance, if the application is an entry system, when the device that is acting as a digital key is initially configured to use the system that is acting as a locking/access device, the presence of the key device may be established by out of band methods such as two factor authentication. Because the legitimacy of the device is not in question at this moment, the communication between the digital key device and the locking device may be monitored at both ends, and each device may refine the parameters of their model to best or more closely match the modulation scheme of their peer. The learning process may also be ongoing, as there may be some aging related shifts. The learning process may be initiated at intervals determined by the system and use data where the system is assured no attacker is present. For example, if the system includes an automobile, when the vehicle has authorized the digital key device to enter or drive the vehicle, the system has determined no attacker is present. At this point, the system may use the received data from one or more receivers in the vehicle to refine the model of the modulation scheme of the digital key device.

### E. Mid Way Overview

At this point it has been established that:
1) A system 100 may know the series of symbols that a legitimate transmitter (the victim transmitter) is expected to transmit;
2) A receiver that has knowledge of the expected series of symbols may build a mathematical reference signal, which is the expectation of the received signal;
3) A receiver that has a reference signal may use a technique to find a timing match of the received signal relative to the reference signal, with cross correlation being provided as an example, but it is to be understand that the present disclosure is not so limited and many other methods are possible;
4) A receiver that has a timing estimate of a received signal vs. a reference signal may mathematically align the signals, and then perform a statistical comparison of the similarity of the signal to compute a security metric;
5) There are impairments that degrade the ability to perform a timing estimate as well as degrade the quality of match between the reference signal and the received signal, where these impairments may lower the accuracy of the timing estimation as well as make it more difficult to distinguish a legitimate signal from a potentially malicious signal; and
6) An attacker may attempt to create a signal that has a desired timing shift without a significant distortion as to go undetected by the security metric.

### F. The Attack

Based upon the modulation properties, frequency band of the signal, and targeted shift in timing, an attacker may implement a negative group delay filter that may make the signal appear earlier than in reality. Often times, the attacker wants to make a device seem closer than it is to a receiver in order to trick the system 100 into allowing access or allowing payment or some other service. Timing advances that make a signal appear earlier are generally considered to be more serious.

FIG. 22 shows a representative view of an attack configuration, with a remote device 20 being provided as a victim transmitter and a sensor 40 being provided as a victim receiver. It is to be understood that the victim transmitter and victim receiver may be different components of the system 100, such that, for example, the victim transmitter may be the sensor 40 and the victim receiver may be the remote device 20. Both the victim transmitter and the victim receiver are shown with antenna assemblies 30, and an attacker 400 disposed between the victim transmitter and the victim receiver. The attacker 400 may include antenna assemblies similar to the antenna assembly 30 of the victim attacker and victim receiver.

In FIG. 22, the victim transmitter 20 transmits a signal that is received by the attacker 400 (e.g., which receives the victim transmitter's signal), while also likely attenuating the signal between the victim transmitter 20 and victim receiver 40 such that the victim receiver 40 is unable to directly observe the victim transmitter 20. The attacker hardware then passes the victim transmitter's signal through a negative group delay filter 410 that outputs a distorted signal. The distortion introduced to the signal is a change in modulation shape that results in a timing advance at the victim receiver 40, a change in gain, and a change in phase related to the filter. The attacker 400 may then amplify the signal coming out of the filter to correct its gain and transmit the attack signal to the victim receiver 40. The victim receiver 40 receives the signal from the attacker and performs a timing match and computes the security metric. If the attacker 400 is successful, the victim receiver 40 may estimate the timing desired by the attacker 400 and the distortion introduced by the attacker 400 may be small enough to not trigger the security metric threshold set on the victim receiver 40.

The attack hardware in FIG. 22 may be built for any modulation scheme at any frequency band where the effectiveness of the system may be based on the limit of how much negative group delay can be created. Generally, the narrower the signal bandwidth the greater the potential to introduce a significant timing advance. The present disclosure describes an implementation of a negative group delay filter 410 that may be effective at manipulating GFSK signals such as the Bluetooth signal.

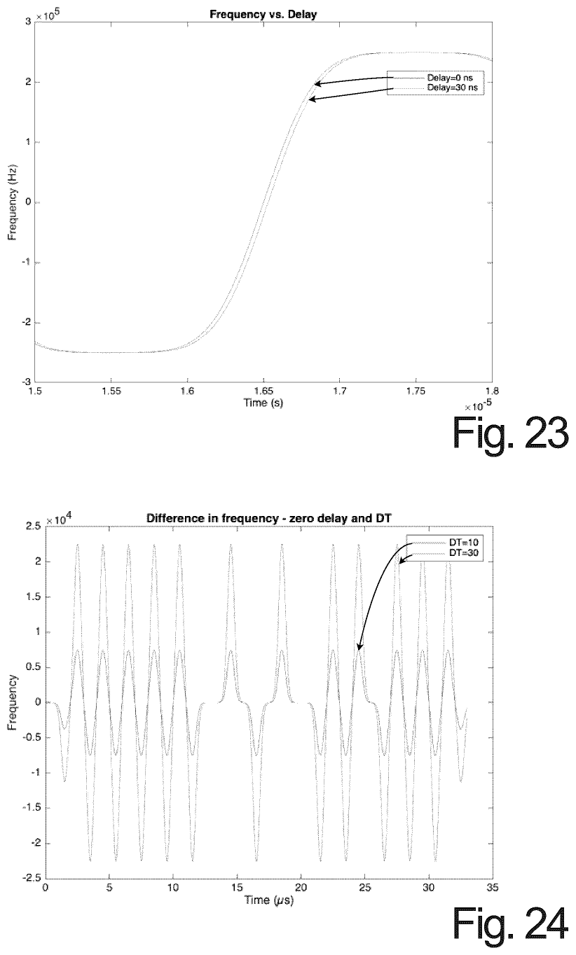

A GFSK signal has a time varying frequency centered upon a carrier frequency. FIG. 23 illustrates what may occur when a GFSK signal is compared to a time delayed version of itself. Around times 1.55e-5 and 1.75e-5, both the 0 ns delay and 30 ns delay signal have the same frequency. These are the times where the GFSK is encoding several successive same symbols, i.e., more than one consecutive 1 or 0 symbol. However, between times 1.6e-5 and 1.7e-5, there is a noticeable frequency difference between the zero delay and 30 ns delay signals. An attacker 400 may create two copies of the victim transmitter's signal by splitting the signal and adding a delay circuitry to one path or both paths, such that there is a controllable delay.

FIG. 24 illustrates the difference in frequencies of a 10 ns (DT=10) and a 30 ns (DT=30) delayed signal compared to a zero-delay version of the signal. The points of interest on FIG. 24 are that the frequency deviation oscillates both positive and negative, the oscillation is aligned with the symbol transition periods (1->0 and 0->1), the stable periods are where there is no symbol transition, the frequency difference goes to zero, and the polarity of the difference is that the delayed signal is a lower frequency when the symbol transition is 0->1 and the delayed signal is a higher frequency when the symbol transition is 1->0. Compared to FIG. 23, the first symbol is a 1, which corresponds to a negative frequency deviation in FIG. 24 where the first dip is located.

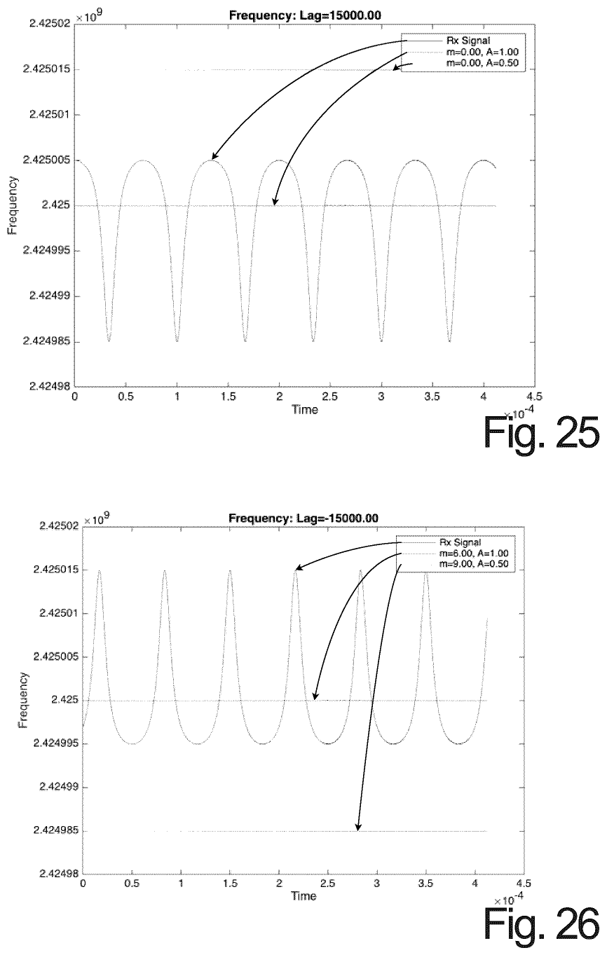

In FIG. 25, a time series is shown of the instantaneous frequency resulting from adding a 2.45e9 Hz sine wave with a 2.425015e9 Hz sine wave with ½ the amplitude of the 2.45e9 Hz sine wave. Initially at time=0, the sine waves are in phase with each other, and the resulting frequency is about 2.425005e9 Hz, which is bound between the two component frequencies. However, there is a 15 kHz difference in frequency between the two component frequencies. This means that with a period of 1/15e3 seconds the two waves may beat past each other. Therefore, at time ˜0.333e-4, the two sine waves are out of phase. When the two sine waves are approximately out of phase, an interesting result occurs—the instantaneous frequency is no longer bound between the two component frequencies. At this approximate out of phase point, the instantaneous frequency is lower than either of the component frequencies.

Turning to FIG. 26, the two component frequencies are changed to 2.425e9 and 2.424985e9 Hz. The same repeating pattern can be observed as in FIG. 25 but mirrored about some horizontal line. The result is that when the two waves are nearly out of phase, the received instantaneous frequency is higher than either of the component signals.

The implications of FIGS. 25 and 26 are that if an attacker 400 can receive the legitimate signal from the victim transmitter 20, the attacker 400 may split the signal and make a time delayed version of the original legitimate signal. The time delayed version, as shown in FIGS. 23 and 24, may have a frequency difference at the symbol transitions, with the amount of frequency deviation being dependent upon the amount of delay as well as the ramp rate of the legitimate signal. The attacker 400 may also manipulate the phase relationship of the two copies of the legitimate signal as well as attenuate the signals such that when the signals are added together, the frequency distortion is the desired amount.

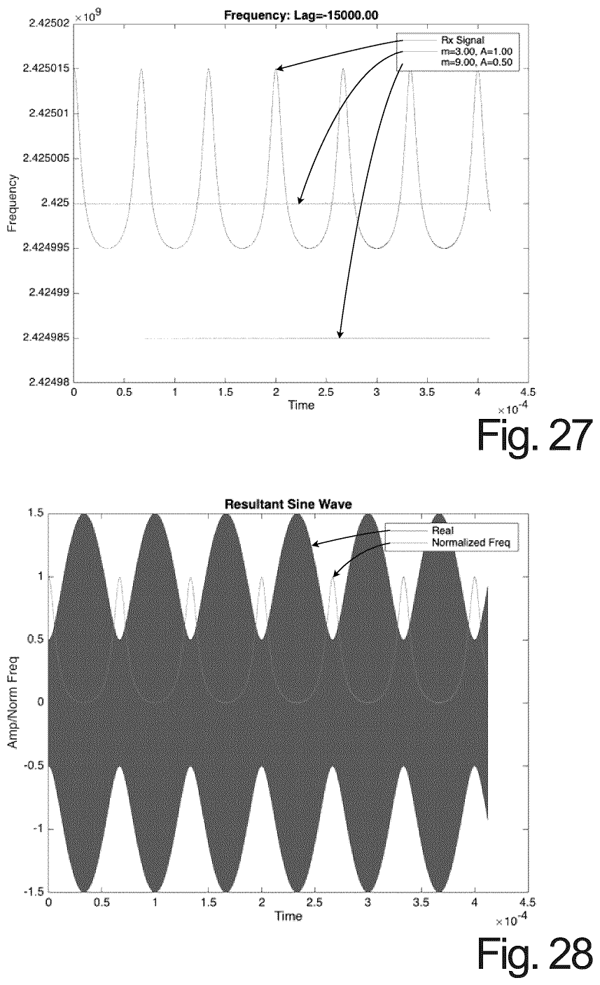

FIG. 27 shows what the resulting instantaneous frequency may be if the attacker 400 received the legitimate signal that has a rising frequency (i.e., the 0->1 symbol transition period). The attacker 400 may split the legitimate signal into Signal A delayed by about 3 meters, or 10 ns; and Signal B, delayed by about 9 meters, or 30 ns; and recombine Signals A and B. The victim receiver 40 may detect the Rx signal, which is higher in frequency than either component frequency, and therefore may predict the symbol transition before it happens, thus acting like a negative group delay filter. It is to be understood that other potential filter designs may be implemented for an attack and that attacks are not limited to GFSK signals. For instance, the system 100 and associated attacks may involve non-GFSK signals.

FIG. 28 shows the normalized frequency of the instantaneous frequency and the magnitude of the resulting received signal. The shape of the normalized frequency signal may be compared to that in FIG. 27. It can be observed in FIG. 28 that where the upward spikes in normalized frequency occur is where the amplitude of the real signal is approximately 0.5. The legitimate signal was received at an amplitude of 1.0, then split, and a delayed signal with amplitude 0.5 is added to make this result. The near perfect out of phase notch causes the frequency distortion that may cause the timing advance in the victim receiver 40. However, the filter may modify the phase and the amplitude of the legitimate signal. Also, the narrowness of the notch makes obtaining a precise frequency deviation challenging. These concepts of phase, amplitude, and sensitivity help to guide efforts to mitigate and detect the attacker's efforts.

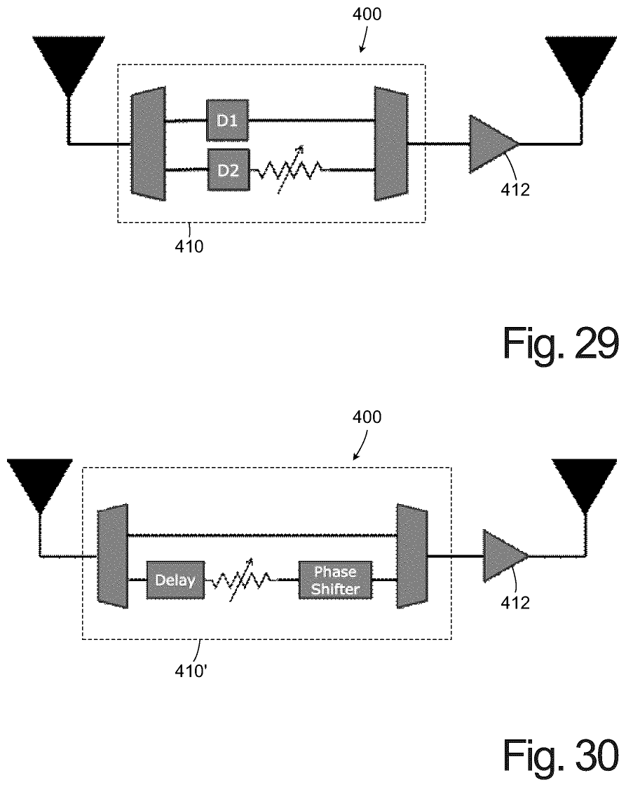

FIG. 29 shows an attacker 400 with group delay circuitry 410 according to one embodiment, with a configuration that provides the equivalent mathematical properties for the attack discussion shown and described in conjunction with FIGS. 25-28, along with an output amplifier 412 to correct for the loss of the group delay circuitry 410 (e.g., filter).

FIG. 30 shows an attacker 400 with group delay circuitry 410′ according to an alternative embodiment, with a configuration that provides mathematical properties described herein similar those of the group delay circuitry 410.

### G. Phase Measurements

The phase of a signal propagating from the victim transmitter 20 to the victim receiver 40 is given by Equation 1, provided that the victim transmitter and victim receiver's PLLs are phase aligned. There are processes for compensating for the non-aligned PLLs that are known in the art and, for purposes of disclosure, this process is not described in greater detail in this section of the disclosure.

$$IQ = exp ( j * - \frac{2 π f * D}{c} ) \qquad Eq . 1$$

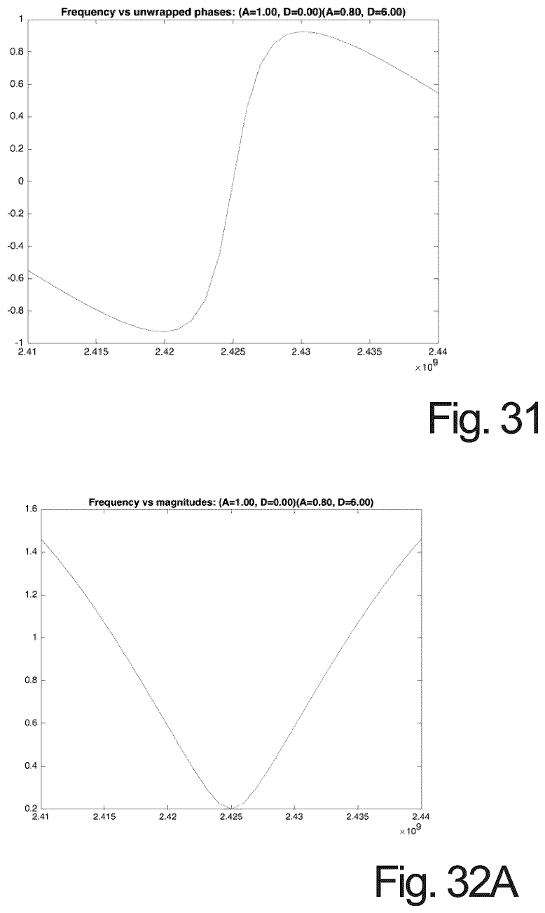

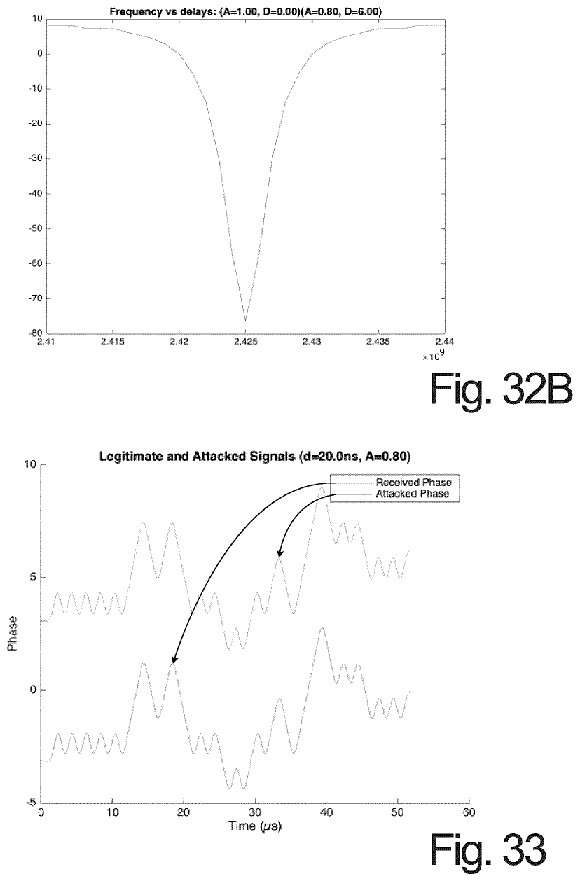

In the illustrated embodiment of FIG. 31, an example of a phase measurement that may result from an attacker 400 is shown that sums a zero delay 1.0 amplitude version of a carrier wave signal and a 20 ns (3 meter) delayed version of the carrier wave. Of interest in Equation 1 is the multiplication term that is dependent on the distance D is negative. Therefore, as the frequency f increases, the phase is expected to decrease. From frequencies 2.41e9 to 2.42e9 and from 2.43e9 to 2.44e9, the phase progression is generally decreasing. However, from frequencies 2.421e9 to 2.429e9, the phase is increasing. This is the area where the frequencies may have a destructive interference pattern. FIG. 32A shows that the amplitude of the IQ measurement in Equation 1 drops dramatically during the area of phase reversal from frequencies 2.421e9 to 2.429e9.

In FIG. 32B, a GFSK signal containing modulated data is sent down the channel depicted in FIGS. 31 and 32A and a timing estimation of the time of arrival of the signal may be performed. The absolute correct answer for the shortest path is 0 ns, because there is a path with zero delay. The longest distance that may be expected is 20 ns (6 meters). Of interest in FIG. 32B is that in the frequency range 2.41e9 to 2.42e9 Hz, where the FIG. 31 phase has a positive slope, there is a notch developing where most of the notch has negative timing estimation. Of additional interest is that the width of the notch is somewhat narrow (10 MHz or so), and that the depth of the notch is severe, nearly reaching −80 ns. However, the steepness of the notch also makes selecting the exact shift in distance sensitive to small errors in frequency. Not shown, but also of interest are small errors in the delay lines of the attacker 400 also creating sensitivity that complicate choosing, setting, and controlling the exact desired parameters.

Again, FIGS. 31, 32A, and 32B illustrate that the attacker 400 creates an amplitude and phase distortion, which may be used as a basis to detect the attack.

FIG. 33 shows that the attacked phase signal has a similar shape as the legitimate received phase signal. However, the attacked phase is shifted along the Y axis compared to the legitimate received phase due to the phase error introduced by the attacker 400.

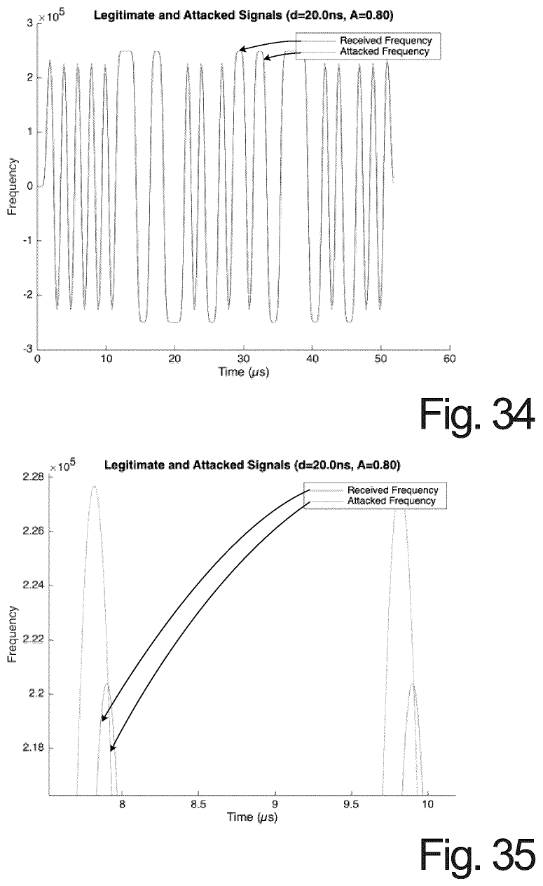

In FIG. 34, the phase error introduced by the attacker is shown removed when looking at the frequency of the signal (a technique for timing match and security metric calculation). The attack signal is nearly identical to the legitimate signal. It may be challenging for the victim receiver 40 to identify the attack signal as an attack signal using a security metric, alone.

FIG. 35 is a close up of some of the frequency peaks of the legitimate received frequency vs. the attacked signal. An approximate 75 ns timing advance is noticeable as the attack signal peaks are left of their corresponding received signal peaks. It is to be noted there is a frequency overshoot as well as a steepening of the slope of the transitions present in the attack signal, which may be one metric for detecting such an attack.

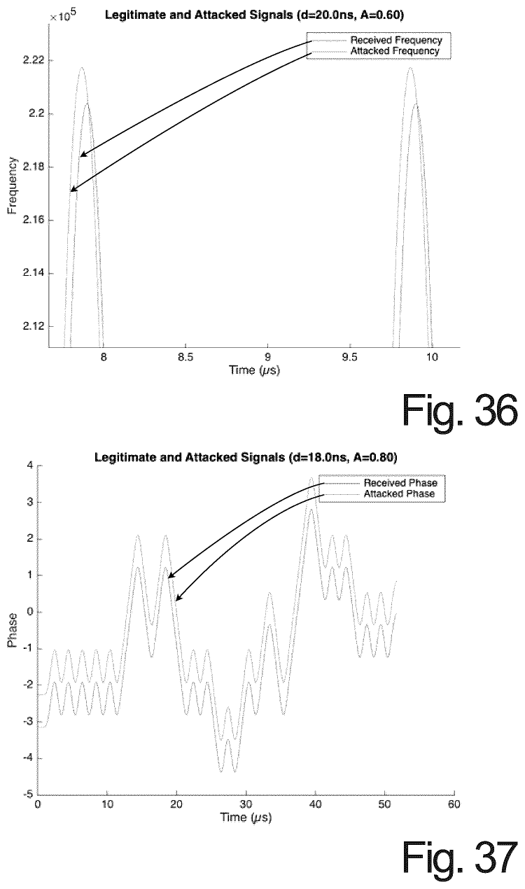

FIG. 36 shows the same information as FIG. 35, but with an attacker using less aggressive settings. The timing advance is still noticeable, but is reduced. However, the similarity between the attack signal and the legitimate signal is increased, and the frequency overshoot is less pronounced.

FIG. 37 can be compared to FIG. 33, where the delay line is changed from 20 to 18 ns. This implies that errors in the attacker's ability to set and control the delay line may introduce phase errors not controlled by the attacker 400, which can be detected by the victim receiver 40.

### H. Countermeasures

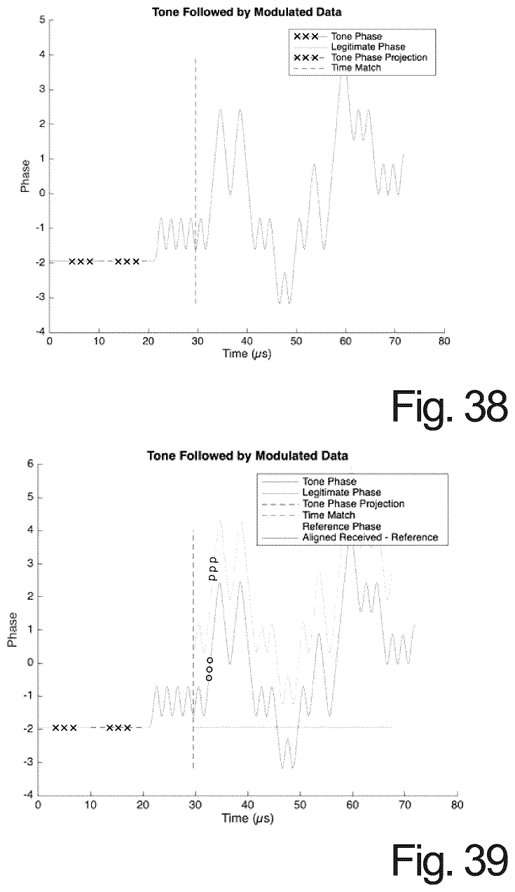

In FIG. 38, the concept of sending a tone as described herein, which may correspond to unmodulated data at the carrier frequency, employed by angle of arrival or phase based ranging systems is shown prior to the modulated data. If the victim transmitter 20 is coherent with the tone that comes before (or after but not shown), the starting phase of the received modulation data may be the same as the ending phase of the tone, minus any drift or impairments which were previously described and may be estimated and removed. The time match line, which is generally where the timing algorithm may determine the time of arrival of the signal has some DC offset in phase compared to the modulation data start. Because this DC offset may be undefined by the radio protocol (e.g., it is not defined by the Bluetooth SIG), a mechanism via either fixing the behavior such that the DC offset in phase of the legitimate signal at the time match is known by specification, or is a value that is known by the victim transmitter 20 and may be reported to the victim receiver 40.

FIG. 39 shows that if the model reference phase can be calculated to have the correct DC offset, either by generating the reference using the exact modulation behavior of the victim, or by starting the reference at zero phase and adjusting the phase according to a correction factor characterized from the victim transmitter 20, that after time aligning the reference to the received signal, the result is that the reference can be subtracted from the received signal, resulting in the Aligned Received-Reference signal, which is phase coherent with the tone.

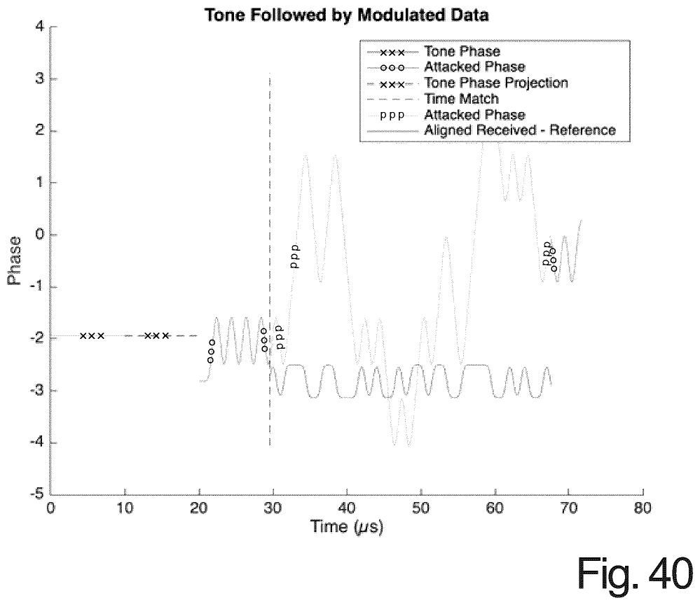

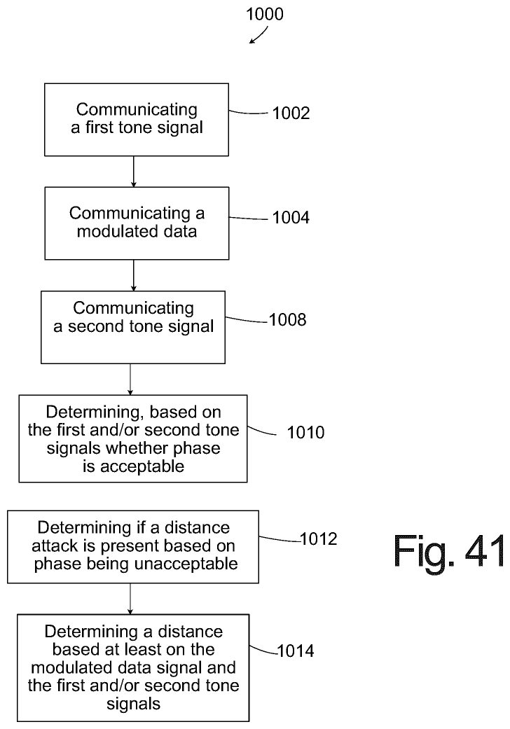

FIG. 40 shows the same information as FIG. 39, but with the phase of the attacked signal at the victim receiver 40. Because the attacker 400 introduced an uncontrolled phase error, the victim receiver 40 may detect that the aligned received-reference signal does not fall on the same phase progression line as the tone and is no longer coherent. The lack in coherency is one signal to the victim receiver 40 that the modulated data has been tampered. Also, the aligned received-reference signal in FIG. 40 has time varying phase distortion not present in FIG. 39. The time varying time distortions are caused by the attacker's negative group delay filter 410. The lack of “flatness” when subtracting the reference from the received signal is another metric that the victim receiver 40 may use to detect the attack. The property of having a victim transmitter 20 start its modulation to be coherent with the tones that come before or after the modulated data on the same channel, and for the phase at the beginning of the timing match interval (e.g., time after the preamble ends and where the data portion of the packet begins) to the known apriori or reportable, allows the victim receiver 40 to make this validation of the expected phase. This forces the attacker 400 to attack both the phase-based ranging and angle of arrival estimate in the tone simultaneously to maintain coherency.

Due to the enhancement in coherency described herein, the attacker 400 may be forced to attack the tones and the modulated data in a way that maintains coherency. This leads to an attack result that can be more easily detectable.

When multiple devices are listening (i.e., there is more than one victim receiver), the victim receivers 40 may also know the channel between each victim receiver 40—such as the configuration described in U.S. Pat. No. 9,794,753 to Stitt et al., entitled SYSTEM AND METHOD FOR ESTABLISHING REAL-TIME LOCATION, issued Oct. 17, 2017—the disclosure of which is incorporated herein by reference in its entirety. And by virtue of the attacker 400 making a manipulation specific to one channel, and employing a high gain antenna to that victim receiver 40, the results at other victim receivers 40 may be inconsistent.

Also, due to the narrowness of the notch of the filter, the victim transmitter 20 may vary its modulation scheme (known to the victim receiver 40). Each edge transition may vary the shape of the edge filter slightly (changing the modulation index and bandwidth time factor from a range of values). For example, in Bluetooth Low Energy a BT=0.5 is specified. The BT=0.5 gives a predictable frequency deviation at the symbol boundaries. By varying the BT and/or modulation index at each edge, the predictability is removed, and therefore it may become impossible or near impossible for the attacker 400 to reliably modify the distance. Over several randomized packets, the average of the distance may have a higher standard deviation than what is expected by the system 100, as well the average may not converge upon the expected value when comparing the measurement of phase based ranging distance estimate to the modulated data distance estimate.

A method of operation according to one embodiment is depicted in FIG. 41 and generally designated 1000. The method may include communicating a first tone signal followed by communication of a modulated data signal. Steps 1002, 1004. A second tone signal may be communicated following the modulated data signal. Step 1008.

Based on the first and/or second tone signals, the system 100 may determine whether the phase of the first and/or second tone signals is acceptable. Step 1010. If the phase is unacceptable, the system 100 may determine that a phase attack is present. Step 1012. In one embodiment, a first phase of communications between devices with respect to the first tone signal may be compared to a first expected phase, and if the first phase corresponds to the first expected phase, the first phase may be determined to be acceptable. Additionally or alternatively, a second phase of communications between devices with respect to the second tone signal may be compared to a second expected phase, and if the second phase corresponds to the second expected phase, the second phase may be determined to be acceptable. If one or both of the first and second phases is unacceptable (e.g., outside a range or above or below a threshold), the system 100 may determine that a distance attack is present.

The method 1000, in one embodiment, may determine a distance attack is present based on at least one of amplitude distortion and a phase distortion in the modulated data signal. The method 1000 include the system 100 establishing coherence with respect to the modulated data signal based on the first and/or second tone signals.

If a phase attack is determined to be absent, the system 100 may determine a distance between devices based on at least one of the modulated data signal, the first tone signal, and the second tone signal. Step 1014. A time of arrival may be determined by the system 100 based on the modulated data signal.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. Any reference to claim elements as “at least one of X, Y and Z” is meant to include any one of X, Y or Z individually, and any combination of X, Y and Z, for example, X, Y, Z; X, Y; X, Z; and Y, Z.

The invention claimed is:

1. A system for determining a distance between a remote device and an object, the system comprising:
a first device disposed in a fixed position relative to the object, the first device including a first antenna system configured to receive and/or transmit communications from and/or to the remote device, the communications including a first tone signal that establishes coherence with respect to the communications between the first device and the remote device;
a control system configured to direct the first device to determine a distance between the first device and the remote device based on the communications between the first antenna system and the remote device; and
the control system configured detect an attack based on distortion in the communications between the first device and the remote device.

2. The system of claim 1 wherein the first tone signal precedes a modulated data signal in the communications between the first device and the remote device.

3. The system of claim 2 wherein the control system is configured to determine a distance between the first device and the remote device based on the first tone signal, and wherein the control system is configured to determine a time of arrival based on the modulated data signal.

4. The system of claim 2 wherein a second tone signal follows the modulated data signal in the communications between the first device and the remote device, and wherein the second tone signal and the first tone signal establish coherence with respect to the communications between the first device and the remote device.

5. The system of claim 1 wherein the control system is configured to determine an estimate of time of arrival based on modulated data of the communications.

6. The system of claim 5 wherein the first device is configured to mitigate the attack by utilizing coherence and time of arrival for the communications between the first antenna system and the remote device.

7. The system of claim 6 wherein coherence and time of arrival are utilized simultaneously.

8. The system of claim 1 comprising a second device disposed in a fixed position relative to the object, the second device including a second antenna system configured to receive and/or transmit a second tone signal from and/or to the remote device.

9. The system of claim 1 wherein the control system is configured to determine a first phase characteristic and a second phase characteristic of the first tone signal at a first frequency and a second frequency, the first and second phase characteristics being indicative of a first phase rotation of the first tone signal between the first device and the remote device, the control system operable to determine a first distance between the first device and the remote device based on the first phase rotation of the first tone signal.

10. A system for determining a distance between a remote device and an object, the system comprising:
a first device disposed in a fixed position relative to the object, the first device including a first antenna system configured to receive and/or transmit communications from and/or to the remote device, the communications including a first tone signal provided at least one of before and after a modulated data signal of the communications;
a control system configured to direct the first device to determine a distance between the first device and the remote device based on the communications between the first antenna system and the remote device; and
the control system configured detect an attack based on distortion in the communications between the first device and the remote device.

11. The system of claim 10, wherein the first tone signal establishes coherence with respect to the communications between the first device and the remote device.

12. The system of claim 10 wherein the first tone signal precedes the modulated data signal in the communications between the first device and the remote device.

13. The system of claim 10 wherein the control system is configured to determine a distance between the first device and the remote device based on the first tone signal, and wherein the control system is configured to determine a time of arrival based on the modulated data signal.

14. The system of claim 13 wherein a second tone signal follows the modulated data signal in the communications between the first device and the remote device, and wherein the second tone signal and the first tone signal establish coherence with respect to the communications between the first device and the remote device.

15. The system of claim 10 wherein the control system is configured to determine an estimate of time of arrival based on modulated data of the communications.

16. The system of claim 10 wherein the first device is configured to mitigate the attack by utilizing coherence and time of arrival for the communications between the first antenna system and the remote device.

17. The system of claim 16 wherein coherence and time of arrival are utilized simultaneously.

18. The system of claim 10 comprising a second device disposed in a fixed position relative to the object, the second device including a second antenna system configured to receive and/or transmit a second tone signal from and/or to the remote device.

19. The system of claim 10 wherein the control system is configured to determine a first phase characteristic and a second phase characteristic of the first tone signal at a first frequency and a second frequency, the first and second phase characteristics being indicative of a first phase rotation of the first tone signal between the first device and the remote device, the control system operable to determine a first distance between the first device and the remote device based on the first phase rotation of the first tone signal.

20. A method of detecting a distance attack between a first device and a remote device, the first device disposed in a fixed position relative to an object, the method comprising:
communicating a modulated data signal between the remote device and the first device;
communicating, before or after the modulated data signal, a first tone signal between the remote device and the first device;
determining, based on the first tone signal, if a phase of the communications between the remote device and the first device corresponds to an expected phase;
determining the distance attack is present based on failure of the phase of the communications to correspond to the expected phase; and
determining, if the distance attack is absent, a distance between the first device and the remote device based on at least one of the modulated data signal and the first tone signal.

21. The method of claim 20 comprising determining the distance attack is present based on at least one of an amplitude distortion and a phase distortion in the modulated data signal.

22. The method of claim 20 comprising establishing coherence with respect to the modulated data signal based on the first tone signal.

23. The method of claim 20 comprising determining a time of arrival based on the modulated data signal.

24. The method of claim 20 comprising:
communicating, after the modulated data signal, a second tone signal between the remote device and the first device, wherein the first tone signal is communicated before the modulated data signal;
determining, based on the second tone signal, if a second phase of the communications between the remote device and the first device corresponds to a second expected phase; and
determining the distance attack is present based on failure of the second phase of the communications to correspond to the second expected phase.

25. The method of claim 20 comprising:
determining a first phase characteristic and a second phase characteristic of the first tone signal at a first frequency and a second frequency, wherein the first and second phase characteristics are indicative of a first phase rotation of the first tone signal between the first device and the remote device; and
determining a first distance between the first device and the remote device based on the first phase rotation of the first tone signal.
